(19) United States
(12) Patent Application Publication
(10) Pub. No.: US 2024/0023087 A1
(43) Pub. Date: Jan. 18, 2024

(54) User Equipment (UE) Uplink Data Transmission Management

(71) Applicant: QUALCOMM Incorporated, San Diego, CA (US)

(72) Inventors: Mickael MONDET, Louannec (FR); Prashanth Haridas HANDE, San Diego, CA (US); Peerapol TINNAKORNSRISUPHAP, San Diego, CA (US); Hyun Yong LEE, San Diego, CA (US); Ravi AGARWAL, San Diego, CA (US); Leena ZACHARIAS, San Jose, CA (US); Chih-Ping LI, San Diego, CA (US)

(21) Appl. No.: 17/812,113

(22) Filed: Jul. 12, 2022

(51) Int. Cl. H04W 72/12; H04W 72/14; H04W 4/20

(52) U.S. Cl. CPC H04W 72/1268; H04W 72/14; H04W 72/1278; H04W 4/20

(57) ABSTRACT

Embodiments of systems and methods for uplink data transmission by a modem processor of user equipment (UE) may include receiving uplink resource grant timing information from a radio access network, the uplink resource grant timing information indicating an uplink transmission opportunity, providing the uplink resource grant timing information to an application executing in a processor of the UE, receiving, from the application, data for transmission to the RAN during the uplink transmission opportunity, and transmitting the data to the RAN during the uplink transmission opportunity.

### BACKGROUND

Long Term Evolution (LTE), Fifth Generation (5G) New Radio (NR), and other communication technologies enable improved communication and data services. One such service is real-time audio and video communication services, such as Voice over Internet Protocol (VoIP), WhatsApp, Facetime, and others. Another such service is computationally intensive services, such as extended reality (XR) applications, in which computational operations for the application are allocated between the mobile device and a network computing device, such as a server. Applications executing on user equipment (UEs) that connect to such services must send and receive a threshold level of data to provide a threshold level of performance, otherwise the performance of such applications degrades. Further, such applications are configured to reduce power consumption of the mobile device.

### SUMMARY

Various aspects include systems and methods performed by user equipment (UE) for transmitting uplink transmission of data, such as data from flows of information, to a communication network. In some embodiments, the UE may receive uplink resource grant timing information from a radio access network (RAN), in which the uplink resource grant timing information indicates an uplink transmission opportunity. The UE may provide the uplink resource grant timing information to an application executing in a processor of the UE. The UE may receive, from the application, data for transmission to the RAN during the uplink transmission opportunity, and may transmit the data to the RAN during the uplink transmission opportunity.

In some aspects, the uplink resource grant timing information provided to the application may include an uplink period and an offset value within the uplink period that enables the application to send the data for transmission to the RAN during the uplink transmission opportunity. In some aspects, receiving the uplink resource grant timing information from the RAN may include receiving the uplink resource grant timing information via radio resource control (RRC) signaling. In some aspects, receiving the uplink resource grant timing information from the RAN may include receiving an indication of an uplink period via RRC signaling and receiving a downlink control information (DCI) that indicates an offset value within the uplink period. In some aspects, receiving the uplink resource grant timing information from the RAN may include receiving uplink grants in a DCI in a pattern that indicates an uplink period and an offset within the uplink period.

In some aspects, receiving, from the application, data for transmission to the RAN during the uplink transmission opportunity may include receiving first application data at a first time and storing the first application data, and receiving second application data at a second time. In such aspects, transmitting the first application data to the RAN during the uplink transmission opportunity may include transmitting the second application data and an uplink transmission request associated with the first application data during the uplink transmission opportunity.

Some aspects may further include receiving, from the application, an indication that it is permissible to store the first application data, wherein receiving first application data at the first time and storing the first application data may include storing the first application data after receiving the indication that it is permissible to store the first application data. Some aspects may further include receiving, from the application, a storage duration for the first application data, and transmitting a scheduling request related to the first application data when the storage duration ends prior to the uplink transmission opportunity. In such aspects, transmitting the data to the RAN during the uplink transmission opportunity may include transmitting the second application data and the uplink transmission request associated with the first application data during the uplink transmission opportunity when the uplink transmission opportunity occurs prior to an end of the storage duration.

In some aspects, receiving, from the application, data for transmission to the RAN during the uplink transmission opportunity may include receiving, from the application at a time prior to the uplink transmit opportunity, first application data that is generated at a first data time and second application data that is generated at a second data time. In such aspects, transmitting the data to the RAN during the uplink transmission opportunity may include transmitting the first application data and an uplink transmission request associated with the second application data during the uplink transmission opportunity. In some aspects, providing the uplink resource grant timing information to the application executing on the processor of the UE may include providing the uplink resource grant timing information to the application via a modem application program interface (API) configured to convey the uplink resource grant timing information to the application. In such aspects, receiving, from the application, data for transmission to the RAN during the uplink transmission opportunity may include receiving, from the application, data for transmission to the RAN via the API associated with the uplink resource grant timing information. In some aspects, receiving, from the application, data for transmission to the RAN via the API associated with the uplink resource grant timing information may include receiving the data for transmission to the RAN at a time that meets a timing drift threshold from the uplink resource grant timing information. Such aspects may include providing a timing adjustment to the application via the API associated with receiving the data for transmission to the RAN at a time that meets a timing drift threshold from the uplink resource grant timing information, and receiving, from the application, second data for transmission to the RAN via the API at a time within the timing drift threshold from the uplink resource grant timing information.

Further aspects include a UE having a processor configured to perform one or more operations of any of the methods summarized above. Further aspects include processing devices for use in a UE configured with processor-executable instructions to perform operations of any of the methods summarized above. Further aspects include a non-transitory processor-readable storage medium having stored thereon processor-executable instructions configured to cause a processor of a UE to perform operations of any of the methods summarized above. Further aspects include a UE having means for performing functions of any of the methods summarized above. Further aspects include a system on chip for use in a UE and that includes a processor configured to perform one or more operations of any of the methods summarized above.

### BRIEF DESCRIPTION OF THE DRAWINGS

FIG. 1A is a system block diagram illustrating an example communications system suitable for implementing any of the various embodiments.

FIG. 1B is a system block diagram illustrating an example disaggregated base station architecture suitable for implementing any of the various embodiments.

FIG. 2 is a component block diagram illustrating an example computing and wireless modem system suitable for implementing any of the various embodiments.

FIG. 3 is a component block diagram illustrating a software architecture including a radio protocol stack for the user and control planes in wireless communications suitable for implementing any of the various embodiments.

FIG. 4 is a component block diagram illustrating elements of a UE 400 configured in accordance with various embodiments.

FIG. 5A is a timeline diagram illustrating the transmission of uplink data by a UE without alignment of the data transmission with granted uplink resources.

FIG. 5B is a timeline diagram illustrating a method of uplink data transmission in accordance with various embodiments.

FIG. 5C is a timeline diagram illustrating the transmission of uplink data by a UE without aggregation of data from different data flows.

FIG. 5D is a timeline diagram illustrating a method of uplink data transmission in accordance with various embodiments.

FIGS. 6A-6D are data flow diagrams illustrating methods for uplink data transmission according to various embodiments.

FIG. 7A is a data flow diagram illustrating the transmission of uplink data by a UE without aggregation of data from different data flows.

FIGS. 7B and 7C are data flow diagrams illustrating methods of uplink data transmission in accordance with various embodiments.

FIG. 7D is a timing diagram illustrating timing of various messages and data transmissions and receptions of different application data flows by a modem of a UE according to various embodiments.

FIGS. 8A and 8B are data flow diagrams illustrating methods for uplink data transmission in accordance with various embodiments.

FIG. 9A is a process flow diagram illustrating a method 900a for uplink data transmission in accordance with various embodiments.

FIGS. 9B-9F illustrate operations that may be performed as part of the method for uplink data transmission according to various embodiments.

FIG. 10 is a component block diagram of a UE suitable for use with various embodiments.

FIG. 11 is a component block diagram of a network device suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments enable a UE to reduce a communication latency of data transmission to a RAN by using uplink resource grant timing information received from the RAN to enable an application being executed by a processor in the UE to provide data to a modem for transmission to the RAN according to the uplink resource grant timing information. The uplink resource grant timing information received from the RAN may include timing of a grant of uplink transmission resources. The data for transmission to the RAN may include application data and/or one or more traffic flows. Various embodiments further enable a UE to increase efficiency of transmitting data to the RAN by delaying transmission of some data (e.g., first application data or a first traffic flow) to the RAN until the UE transmits other data (e.g., second application data or a second traffic flow) to the RAN.

The term “user equipment” (UE) is used herein to refer to any one or all of wireless communication devices, wireless appliances, cellular telephones, smartphones, portable computing devices, personal or mobile multi-media players, laptop computers, tablet computers, smartbooks, ultrabooks, palmtop computers, wireless electronic mail receivers, multimedia Internet-enabled cellular telephones, wireless router devices, medical devices and equipment, biometric sensors/devices, wearable devices including smart watches, smart clothing, smart glasses, smart wrist bands, smart jewelry (for example, smart rings and smart bracelets), entertainment devices (for example, wireless gaming controllers, music and video players, satellite radios, etc.), wireless-network enabled Internet of Things (IoT) devices including smart meters/sensors, industrial manufacturing equipment, large and small machinery and appliances for home or enterprise use, wireless communication elements within autonomous and semiautonomous vehicles, wireless devices affixed to or incorporated into various mobile platforms, and similar electronic devices that include a memory, wireless communication components and a programmable processor.

The term “system on chip” (SOC) is used herein to refer to a single integrated circuit (IC) chip that contains multiple resources or processors integrated on a single substrate. A single SOC may contain circuitry for digital, analog, mixed-signal, and radio-frequency functions. A single SOC also may include any number of general purpose or specialized processors (digital signal processors, modem processors, video processors, etc.), memory blocks (such as ROM, RAM, Flash, etc.), and resources (such as timers, voltage regulators, oscillators, etc.). SOCs also may include software for controlling the integrated resources and processors, as well as for controlling peripheral devices.

The term “system in a package” (SIP) may be used herein to refer to a single module or package that contains multiple resources, computational units, cores or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP also may include multiple independent SOCs coupled together via high speed communication circuitry and packaged in close proximity, such as on a single motherboard or in a single wireless device. The proximity of the SOCs facilitates high speed communications and the sharing of memory and resources.

As used herein, the terms “network,” “system,” “wireless network,” “cellular network,” and “wireless communication network” may interchangeably refer to a portion or all of a wireless network of a carrier associated with a wireless device and/or subscription on a wireless device. The techniques described herein may be used for various wireless communication networks, such as Code Division Multiple Access (CDMA), time division multiple access (TDMA), FDMA, orthogonal FDMA (OFDMA), single carrier FDMA (SC-FDMA) and other networks. In general, any number of wireless networks may be deployed in a given geographic area. Each wireless network may support at least one radio access technology, which may operate on one or more frequency or range of frequencies. For example, a CDMA network may implement Universal Terrestrial Radio Access (UTRA) (including Wideband Code Division Multiple Access (WCDMA) standards), CDMA2000 (including IS-2000, IS-95 and/or IS-856 standards), etc. In another example, a TDMA network may implement Enhanced Data rates for global system for mobile communications (GSM) Evolution (EDGE). In another example, an OFDMA network may implement Evolved UTRA (E-UTRA) (including LTE standards), Institute of Electrical and Electronics Engineers (IEEE) 802.11 (Wi-Fi), IEEE 802.16 (WiMAX), IEEE 802.20, Flash-OFDM®, etc. Reference may be made to wireless networks that use LTE standards, and therefore the terms “Evolved Universal Terrestrial Radio Access,” “E-UTRAN” and “eNodeB” may also be used interchangeably herein to refer to a wireless network. However, such references are provided merely as examples, and are not intended to exclude wireless networks that use other communication standards. For example, while various Third Generation (3G) systems, Fourth Generation (4G) systems, and Fifth Generation (5G) systems are discussed herein, those systems are referenced merely as examples and future generation systems (e.g., sixth generation (6G) or higher systems) may be substituted in the various examples.

Applications executing in processor of UEs that provide real-time audio and video communication services, such as Voice over Internet Protocol (VoIP), WhatsApp, Facetime, and others, typically send and receive a threshold level of data to provide a threshold level of performance. Without sending and receiving the threshold level of data the performance of such applications may degrade over time. Similarly, extended reality (XR) applications (which include, for example, virtual reality (VR), augmented reality (AR), and other similar services and applications) may be configured to share, exchange, or coordinate competition tasks with a network computing device, such as a server. In some applications, a “split-XR” application or service may divide or allocate competition tasks between a network computing device and a UE. For example, UE or user pose information may be sent in an uplink communication link to a network computing device that renders video frames, and the network computing device may send rendered video frames to the UE in a downlink communication link to be displayed on a display device of the UE. Such applications are generally referred to as being “latency sensitive” because the ability to provide a threshold level of performance requires relatively low uplink and/or downlink latency, otherwise the performance of such applications may degrade. Further, such applications are configured to reduce power consumption of mobile devices, which are typically battery powered.

To reduce data latency in the transmission of data to a communication network in a power-efficient manner, a UE may perform operations to align traffic flows to the timing of uplink transmission opportunities, such as periodic uplink grants, that are received from the communication network (e.g., from a network element of a radio access network (RAN), such as a base station). In some embodiments, a UE may be configured so that a modem of the UE receives data for transmission to the RAN at a time that is coordinated with an uplink transmission opportunity. Configuring the modem to receive data for transmission to the RAN at times coordinated with uplink transmission opportunities is sometimes referred to herein as “aligning” traffic flows or application data with uplink communication resources or uplink transmission opportunities. If uplink traffic is aligned to uplink communication resources or uplink transmission opportunities, the latency in such data transmissions is reduced. For example, in some cases the data for transmission to the RAN may be received by the modem from the application “just-in-time” for the modem to process such data for transmission to the RAN.

To increase data communication efficiency and reduce power consumption by the UE, the UE may perform operations to store (e.g., buffer) application data from a first traffic flow and then transmit the stored application data from the first traffic flow at a later time when second application data is transmitted to the RAN. Such operations are sometimes referred to herein as “aggregating” traffic flows or application data for transmission to the RAN. In some embodiments, the UE may delay transmission of information from a non-latency sensitive traffic flow until the UE transmits information from a latency sensitive traffic flow, thereby aggregating for transmission data of non-latency sensitive traffic flows with data of latency sensitive traffic flow. In various embodiments, the aggregation of traffic flows or application data for transmission to the RAN may be accomplished within an application executing in an application processor or within a modem of the UE.

In some embodiments, an application executing in an application processor in the UE that sends traffic flows to the modem for transmission to the RAN may perform operations to aggregate traffic flows. In such embodiments, the application may deliver information from aggregated flows to the modem of the UE at substantially the same time as data of aligned traffic flows. For example, the application may store information from a first traffic flow until the modem is scheduled to transmit information from a second traffic flow to the RAN. Because delivering the information from the first, non-latency sensitive, traffic flow to the modem may trigger the modem to transmit a scheduling request to the RAN, storing the information from the first traffic flow by the application avoids triggering the modem to transmit the scheduling request. The application may deliver the stored information from the first traffic flow to the modem at a later time when the modem is scheduled to transmit information from a second, latency sensitive, traffic flow to the RAN.

In some embodiments, the modem of the UE may perform operations to aggregate traffic flows. In such embodiments, the modem may buffer data from aggregated traffic flows and transmit the data from aggregate traffic flows at substantially the same time as data from aligned traffic flows.

In some embodiments, the UE (e.g., a modem in the UE) may receive from the RAN uplink resource grant timing information indicating an uplink transmission opportunity, and provide the uplink resource grant timing information to an application executing in a processor of the UE. In response, the UE (e.g., a modem in the UE) may receive data from the application for transmission to the RAN during the uplink transmission opportunity, enabling the UE to transmit the data to the RAN during the uplink transmission opportunity without delay.

For example, when the application launches on the UE, the UE may begin performing operations for a session establishment procedure, including sending a session establishment request. A network element of the communication network (e.g., in the core network) may accept the session establishment request and may configure the RAN, including, for example, quality of service (QoS) profile of data traffic or traffic flows of information for the application. The RAN may configure wireless communication link resources for sending and receiving information of the traffic flows, for example, based on a configuration message received from the core network.

In some embodiments, the RAN may identify a timing of anticipated uplink traffic from the UE, such as by scheduling periodic timing of uplink traffic, and may configure wireless communication link resources appropriately (e.g., periodic communication link resources). In some embodiments, the configuration of periodic resources may be total or partial.

When the communication session is established, the modem of the UE may receive from the RAN a grant of uplink communication resources, which may include uplink resource grant timing information indicating an upcoming uplink transmission opportunity for the UE to transmit application data in the uplink to the RAN. The modem of the UE may provide to the application an indication that the modem is prepared to transmit uplink data traffic, and send, report, or otherwise provide the uplink resource grant timing information to the application. Providing the uplink resource grant timing information to the application may enable the application to schedule or control providing data for transmission to the modem according to or based on the uplink resource grant timing information. The modem may then transmit the data on the uplink resources (e.g., periodic uplink resources).

In some embodiments, the uplink resource grant timing information provided to the application may include an uplink period (a time during which the modem may transmit data to the RAN) and an offset value within the uplink period that enables the application to send the data for transmission to the RAN during the uplink transmission opportunity. In some embodiments, the offset value may include a time value, a slot offset, or another time value that the application may use to send application data to the modem.

In some embodiments, the UE (e.g., the modem) may receive the uplink resource grant timing information via radio resource control (RRC) signaling from the RAN. In some embodiments, the UE may receive the uplink resource grant timing information by RRC signaling, and may receive a downlink control information (DCI) that indicates an offset value within the uplink period. In some embodiments, the uplink period and the offset value may be explicitly signaled by the RAN to the UE, for example, in a message explicitly providing the uplink. In some embodiments, the UE may determine the uplink period and the offset value using one or more aspects of an uplink grant message, which may not include explicit signaling of the uplink period or the offset value. For example, the UE may receive uplink grants from the RAN in a DCI in a pattern that indicates an uplink period and the offset value within the uplink period.

In some embodiments, an uplink resource grant may include a periodic uplink resource grant. A periodic uplink resource grant may include a Configured Grant (CG) Type 1, a CG Type 2, and a Dynamic Grant.

In a CG Type 1, the RAN may provide an indication of the uplink period and the offset value via RRC signaling (e.g., an RRC signal or an RRC message).

In some embodiments, the UE may identify the periodic uplink resource grants from a CG Type 1 configuration in an RRC signal or message.

In a CG Type 2, the RAN may provide a partial configuration of the uplink resource grants, such as an indication of the uplink period, but without an indication of the offset value, via RRC signaling. The RAN may provide information or a signal indicating the offset value during an activation period using a DCI (e.g., a DCI format 0_1) scrambled by a Configured Scheduling Radio Network Temporary Identifier (CS-RNTI).

In some embodiments, the UE may identify the periodic uplink resource grants from the CG Type 2 configuration of the RRC message were signaling (such as the uplink period), and may identify the offset value based on a time (e.g., a time slot) in which the DCI scrambled by the CS-RNTI is received.

In a Dynamic Grant, the RAN may send uplink resource grants periodically via a DCI scrambled by a Cell RNTI (C-RNTI). In some embodiments, the UE may determine a periodic pattern of the received DCIs scrambled by a C-RNTI (for example, by applying an algorithm to analyze the periodic pattern of the received DCIs). For example, the UE may identify that some uplink resource grants with a similar Transport Block Size (TBS) are received periodically.

In some embodiments, the UE may aggregate traffic flows or application data for transmission to the RAN by storing application data from a first traffic flow (including first application data) and later transmit the stored (first) application data along with second application data to the RAN. In some embodiments, the UE may receive the first application data at a first time and store the first application data, and receive second application data at a second time, and then transmit the second application data and an uplink transmission request associated with the first application data during the uplink transmission opportunity. The UE may receive an uplink resource grant to transmit the first application data, and may transmit the first application data using the granted uplink resources. In some embodiments, an uplink transmission request may include a Scheduling Request (SR), a Buffer Status Report (BSR), or another suitable request for uplink resources. In some embodiments, storing the first application data avoids or prevents the modem from sending an uplink transmission request associated with the first application data, which may enable the modem to remain in a brief sleep mode or brief low-power mode (e.g., a discontinuous reception (DRX) sleep period), thereby conserving battery power of the UE.

In some embodiments, the modem may receive from the application an indication that the modem may store the first application data (i.e., an indication that it is permissible to store the first application data). For example, the first application data may be non-latency sensitive data, which may be stored and transmitted to the RAN at a later time without degrading the performance of the application. In such embodiments, the modem may store the first application data based on or responsive to (e.g., associated with) the indication from the application that it is permissible to store the first application data. For example, the modem may receive from the application an indication or identification of which application data the modem is permitted to or should store for delayed transmission. The application may provide such signaling or identification when the application launches, or at any time while the application is executing. The application also may provide signaling or an indication changing whether certain application data should be, or is permitted to be, stored for delayed transmission by the modem. In some embodiments, the modem may include an Application Program Interface (API) that is configured to enable the sending and receiving of such indications or identification information.

In some embodiments, the stored first application data may not be associated with an indication that it is available for transmission to the RAN, and lacking such indication, the modem may not send a scheduling request to the RAN for the first application data. In some embodiments, the modem may receive from the application a storage duration for, or associated with, the first application data. In such embodiments, the modem may transmit the second application data and an uplink transmission request associated with the first application data during the uplink transmission opportunity when the uplink transmission opportunity occurs prior to an end of the storage duration (e.g., in response to determining that the storage duration has not ended prior to the uplink transmission opportunity). In the event that the storage duration ends prior to the uplink transmission opportunity (e.g., in response to determining that the storage duration ends prior to the uplink transmission opportunity), the modem may transmit a Scheduling Request (SR) related to the stored first application data to the RAN to request uplink communication resources to enable the modem to transmit the first application data to the RAN. In some embodiments, the modem may include an API that is configured to enable the sending and receiving of information including the storage duration.

The application generating the application data may have a better ability (e.g., based on greater access to all aspects of the application data) than the modem to determine whether generated application data is latency sensitive. In some embodiments, the application may determine certain application data to store temporarily (e.g., buffer by the application), and certain application data to send to the modem for transmission to the RAN. In some embodiments, the application may send both recently generated data (e.g., first application data) and stored application data (e.g., second application data) to the modem for transmission to the RAN. In some embodiments, the modem may receive from the application, at a time prior to the uplink transmit opportunity, the first application data that is generated at a first data time and the second application data that is generated at a second data time. In such embodiments, the modem may transmit the first application data and an uplink transmission request associated with the second application data during the uplink transmission opportunity (e.g., the periodic uplink grant).

As noted above, in some embodiments the modem may be configured with an API that enables communication of information between the modem and the application, such as uplink resource grant timing information, uplink period information, an offset value, indications that application data is permitted to be stored, storage duration information of application data, and similar information.

In some embodiments, the modem may provide uplink resource grant timing information to the application via the modem API, and the modem may receive data from the application for transmission to the RAN via the API according to (e.g., associated with) the uplink resource grant timing information. In some embodiments, the API may include a semi-static API by which the modem provides uplink resource grant timing information (e.g., uplink period information and/or offset value) to the application. In such embodiments, the application may be configured to determine accurately the timing of uplink resource grants, and the application may select application data or data flows to send to the modem, and may select a timing at which the application sends such application data to the modem.

In some embodiments, the API may include a dynamic API by which the modem may provide timing adjustment information to the application that the application may use to adjust the timing by which it sends application data to the modem. In some embodiments, the application may not be configured to determine accurately the timing of uplink resource grants, and the modem may monitor the timing of receipt of application data from the application for a timing drift from the uplink resource grant timing information. For example, the modem may determine whether application data is received the modem may determine whether application data is received.

In some embodiments, the modem may provide a timing adjustment to the application to enable the application to adjust forward or backward the timing by which the application sends application data to the modem. In some embodiments, the modem may receive data from the application at a time that meets a timing drift threshold from the uplink resource grant timing information. In such embodiments, the modem may provide a timing adjustment to the application via the API associated with receiving the data for transmission to the RAN at a time that meets a timing drift threshold from the uplink resource grant timing information. The modem may receive second data from the application for transmission to the RAN via the API at a time within the timing drift threshold from the uplink resource grant timing information. In some embodiments, the application may send to the modem an identification or signal indicating that the timing of one or more traffic flows or application data are permitted to be monitored by the modem.

Various embodiments improve wireless communications by enabling a UE to reduce a communication latency of data transmission to a RAN by using timing information received from the RAN, such as timing of a grant of uplink transmission resources, to enable an application executing on the UE to provide data for transmission to the RAN (e.g., application data, or one or more traffic flows) to the modem for transmission to the RAN. Various embodiments further improve wireless communications by enabling a UE to delay transmission of some data (e.g., first application data, or a first traffic flow) to the RAN until the UE transmits other data (e.g., second application data, or a second traffic flow) to the RAN.

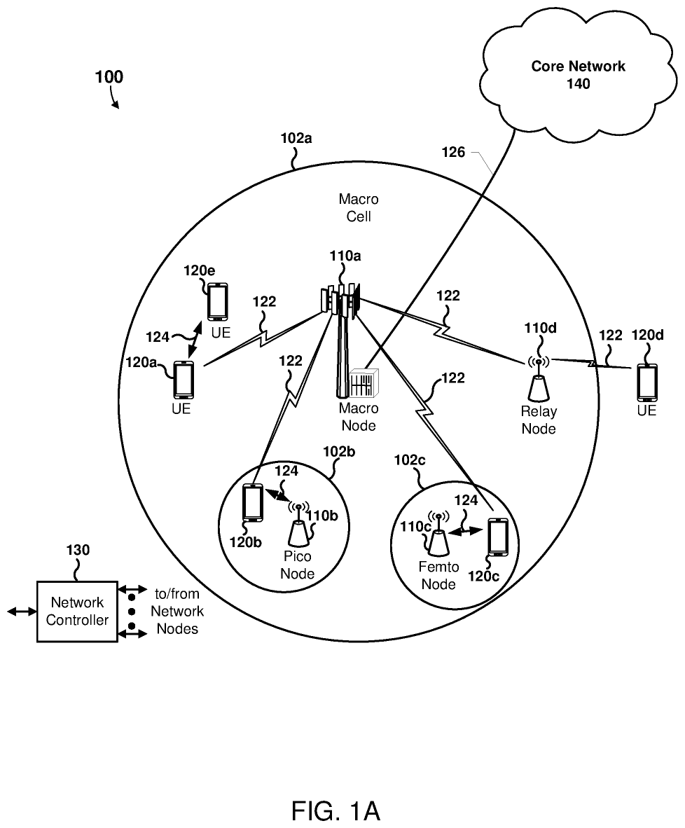

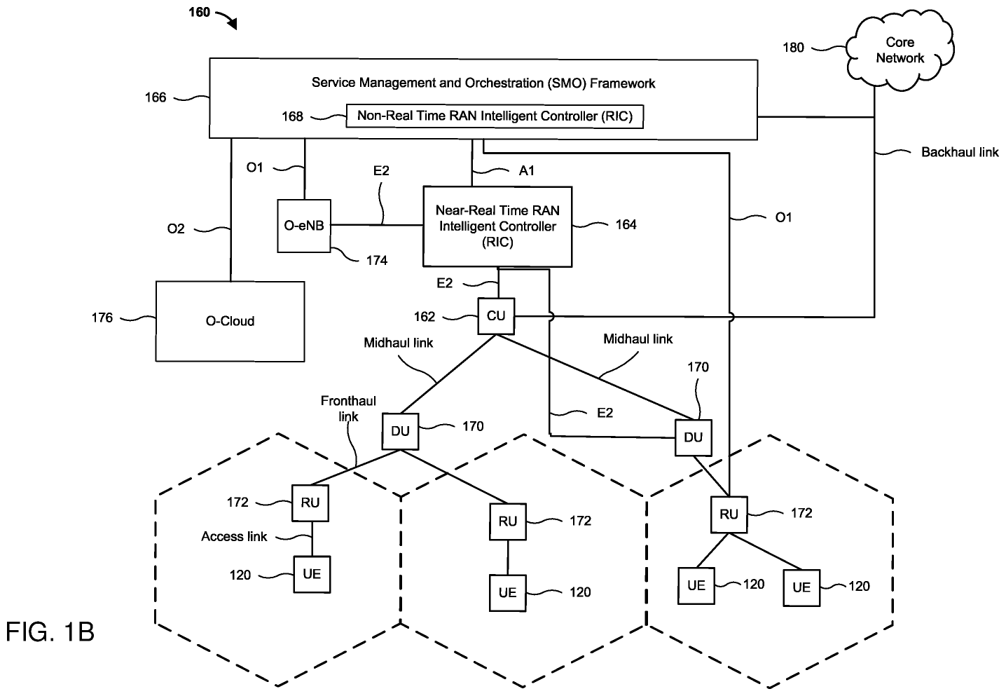

FIG. 1A is a system block diagram illustrating an example communications system 100 suitable for implementing any of the various embodiments. The communications system 100 may be a 5G New Radio (NR) network, or any other suitable network such as a Long Term Evolution (LTE) network. While FIG. 1A illustrates a 5G network, later generation networks may include the same or similar elements. Therefore, the reference to a 5G network and 5G network elements in the following descriptions is for illustrative purposes and is not intended to be limiting.

The communications system 100 may include a heterogeneous network architecture that includes a core network 140 and a variety of UEs (illustrated as UEs 120a-120e in FIG. 1A). The communications system 100 also may include a number of network devices 110a, 110b, 110c, and 110d and other network entities, such as base stations and network nodes. A network device is an entity that communicates with UEs, and in various embodiments may be referred to as a Node B, an LTE Evolved nodeB (eNodeB or eNB), an access point (AP), a radio head, a transmit receive point (TRP), a New Radio base station (NR BS), a 5G NodeB (NB), a Next Generation NodeB (gNodeB or gNB), or the like. In various communication network implementations or architectures, a network device may be implemented as an aggregated base station, as a disaggregated base station, an integrated access and backhaul (IAB) node, a relay node, a sidelink node, etc., such as a virtualized Radio Access Network (vRAN) or Open Radio Access Network (O-RAN). Also, in various communication network implementations or architectures, a network device (or network entity) may be implemented in an aggregated or monolithic base station architecture, or alternatively, in a disaggregated base station architecture, may include one or more of a Centralized Unit (CU), a Distributed Unit (DU), a Radio Unit (RU), a near-real time (RT) RAN intelligent controller (RIC), or a non-real time RIC.

Each network device may provide communication coverage for a particular geographic area. In 3GPP, the term “cell” can refer to a coverage area of a network device, a network device subsystem serving this coverage area, or a combination thereof, depending on the context in which the term is used. The core network 140 may be any type core network, such as an LTE core network (e.g., an evolved packet core (EPC) network), 5G core network, etc.

A network device 110a-110d may provide communication coverage for a macro cell, a pico cell, a femto cell, another type of cell, or a combination thereof. A macro cell may cover a relatively large geographic area (for example, several kilometers in radius) and may allow unrestricted access by UEs with service subscription. A pico cell may cover a relatively small geographic area and may allow unrestricted access by UEs with service subscription. A femto cell may cover a relatively small geographic area (for example, a home) and may allow restricted access by UEs having association with the femto cell (for example, UEs in a closed subscriber group (CSG)). A network device for a macro cell may be referred to as a macro node or macro base station. A network device for a pico cell may be referred to as a pico node or a pico base station. A network device for a femto cell may be referred to as a femto node, a femto base station, a home node or home network device. In the example illustrated in FIG. 1A, a network device 110a may be a macro node for a macro cell 102a, a network device 110b may be a pico node for a pico cell 102b, and a network device 110c may be a femto node for a femto cell 102c. A network device 110a-110d may support one or multiple (for example, three) cells. The terms “network device,” “network node,” “eNB,” “base station,” “NR BS,” “gNB,” “TRP,” “AP,” “node B,” “5G NB,” and “cell” may be used interchangeably herein.

In some examples, a cell may not be stationary, and the geographic area of the cell may move according to the location of a network device, such as a network node or mobile network device. In some examples, the network devices 110a-110d may be interconnected to one another as well as to one or more other network devices (e.g., base stations or network nodes (not illustrated)) in the communications system 100 through various types of backhaul interfaces, such as a direct physical connection, a virtual network, or a combination thereof using any suitable transport network

The network device 110a-110d may communicate with the core network 140 over a wired or wireless communication link 126. The UE 120a-120e may communicate with the network node 110a-110d over a wireless communication link 122. The wired communication link 126 may use a variety of wired networks (such as Ethernet, TV cable, telephony, fiber optic and other forms of physical network connections) that may use one or more wired communication protocols, such as Ethernet, Point-To-Point protocol, High-Level Data Link Control (HDLC), Advanced Data Communication Control Protocol (ADCCP), and Transmission Control Protocol/Internet Protocol (TCP/IP).

The communications system 100 also may include relay stations (such as relay network device 110d). A relay station is an entity that can receive a transmission of data from an upstream station (for example, a network device or a UE) and send a transmission of the data to a downstream station (for example, a UE or a network device). A relay station also may be a UE that can relay transmissions for other UEs. In the example illustrated in FIG. 1A, a relay station 110d may communicate with macro the network device 110a and the UE 120d in order to facilitate communication between the network device 110a and the UE 120d. A relay station also may be referred to as a relay network device, a relay base station, a relay, etc.

The communications system 100 may be a heterogeneous network that includes network devices of different types, for example, macro network devices, pico network devices, femto network devices, relay network devices, etc. These different types of network devices may have different transmit power levels, different coverage areas, and different impacts on interference in communications system 100. For example, macro nodes may have a high transmit power level (for example, 5 to 40 Watts) whereas pico network devices, femto network devices, and relay network devices may have lower transmit power levels (for example, 0.1 to 2 Watts).

A network controller 130 may couple to a set of network devices and may provide coordination and control for these network devices. The network controller 130 may communicate with the network devices via a backhaul. The network devices also may communicate with one another, for example, directly or indirectly via a wireless or wireline backhaul.

The UEs 120a, 120b, 120c may be dispersed throughout communications system 100, and each UE may be stationary or mobile. A UE also may be referred to as an access terminal, a terminal, a mobile station, a subscriber unit, a station, wireless device, etc.

A macro network device 110a may communicate with the communication network 140 over a wired or wireless communication link 126. The UEs 120a, 120b, 120c may communicate with a network device 110a-110d over a wireless communication link 122.

The wireless communication links 122 and 124 may include a plurality of carrier signals, frequencies, or frequency bands, each of which may include a plurality of logical channels. The wireless communication links 122 and 124 may utilize one or more radio access technologies (RATs). Examples of RATs that may be used in a wireless communication link include 3GPP LTE, 3G, 4G, 5G (such as NR), GSM, Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies cellular RATs. Further examples of RATs that may be used in one or more of the various wireless communication links within the communication system 100 include medium range protocols such as Wi-Fi, LTE-U, LTE-Direct, LAA, MuLTEfire, and relatively short range RATs such as ZigBee, Bluetooth, and Bluetooth Low Energy (LE).

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block”) may be 12 subcarriers (or 180 kHz). Consequently, the nominal Fast File Transfer (FFT) size may be equal to 128, 256, 512, 1024 or 2048 for system bandwidth of 1.25, 2.5, 5, 10 or 20 megahertz (MHz), respectively. The system bandwidth also may be partitioned into subbands. For example, a subband may cover 1.08 MHz (i.e., 6 resource blocks), and there may be 1, 2, 4, 8 or 16 subbands for system bandwidth of 1.25, 2.5, 5, 10 or 20 MHz, respectively.

While descriptions of some implementations may use terminology and examples associated with LTE technologies, some implementations may be applicable to other wireless communications systems, such as a new radio (NR) or 5G network. NR may utilize OFDM with a cyclic prefix (CP) on the uplink (UL) and downlink (DL) and include support for half-duplex operation using Time Division Duplex (TDD). A single component carrier bandwidth of 100 MHz may be supported. NR resource blocks may span 12 sub-carriers with a sub-carrier bandwidth of 75 kHz over a 0.1 millisecond (ms) duration. Each radio frame may consist of 50 subframes with a length of 10 ms. Consequently, each subframe may have a length of 0.2 ms. Each subframe may indicate a link direction (i.e., DL or UL) for data transmission and the link direction for each subframe may be dynamically switched. Each subframe may include DL/UL data as well as DL/UL control data. Beamforming may be supported and beam direction may be dynamically configured. Multiple Input Multiple Output (MIMO) transmissions with precoding also may be supported. MIMO configurations in the DL may support up to eight transmit antennas with multi-layer DL transmissions up to eight streams and up to two streams per UE. Multi-layer transmissions with up to 2 streams per UE may be supported.

Aggregation of multiple cells may be supported with up to eight serving cells. Alternatively, NR may support a different air interface, other than an OFDM-based air interface.

Some UEs may be considered machine-type communication (MTC) or evolved or enhanced machine-type communication (eMTC) UEs. MTC and eMTC UEs include, for example, robots, remote devices, sensors, meters, monitors, location tags, etc., that may communicate with a network device, another device (for example, remote device), or some other entity. A wireless computing platform may provide, for example, connectivity for or to a network (for example, a wide area network such as Internet or a cellular network) via a wired or wireless communication link. Some UEs may be considered Internet-of-Things (IoT) devices or may be implemented as NB-IoT (narrowband internet of things) devices. The UE 120a-120e may be included inside a housing that houses components of the UE 120a-120e, such as processor components, memory components, similar components, or a combination thereof.

In general, any number of communications systems and any number of wireless networks may be deployed in a given geographic area. Each communications system and wireless network may support a particular radio access technology (RAT) and may operate on one or more frequencies. A RAT also may be referred to as a radio technology, an air interface, etc. A frequency also may be referred to as a carrier, a frequency channel, etc. Each frequency may support a single RAT in a given geographic area in order to avoid interference between communications systems of different RATs. In some cases, 4G/LTE and/or 5G/NR RAT networks may be deployed. For example, a 5G non-standalone (NSA) network may utilize both 4G/LTE RAT in the 4G/LTE RAN side of the 5G NSA network and 5G/NR RAT in the 5G/NR RAN side of the 5G NSA network. The 4G/LTE RAN and the 5G/NR RAN may both connect to one another and a 4G/LTE core network (e.g., an EPC network) in a 5G NSA network. Other example network configurations may include a 5G standalone (SA) network in which a 5G/NR RAN connects to a 5G core network.

In some implementations, two or more UEs 120a-120e (for example, illustrated as the UE 120a and the UE 120e) may communicate directly using one or more sidelink channels 124 (for example, without using a network node 110a-110d as an intermediary to communicate with one another). For example, the UEs 120a-120e may communicate using peer-to-peer (P2P) communications, device-to-device (D2D) communications, a mesh network, or similar networks, a vehicle-to-everything (V2X) protocol (which may include a vehicle-to-vehicle (V2V) protocol, a vehicle-to-infrastructure (V2I) protocol, or a similar protocol), or combinations thereof. In this case, the UE 120a-120e may perform scheduling operations, resource selection operations, as well as other operations described elsewhere herein as being performed by the network node 110a-110d.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or components) performing base station functionality, may be implemented in an aggregated or disaggregated architecture. For example, a base station (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or as a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CUs, DUs and RUs also can be implemented as virtual units, referred to as a virtual central unit (VCU), a virtual distributed unit (VDU), or a virtual radio unit (VRU).

Base station-type operations or network design may consider aggregation characteristics of base station functionality. For example, disaggregated base stations may be utilized in an integrated access backhaul (IAB) network, an open radio access network (O-RAN) (such as the network configuration sponsored by the O-RAN Alliance), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 1B is a system block diagram illustrating an example disaggregated base station 160 architecture suitable for implementing any of the various embodiments. With reference to FIGS. 1A and 1B, the disaggregated base station 160 architecture may include one or more central units (CUs) 162 that can communicate directly with a core network 180 via a backhaul link, or indirectly with the core network 180 through one or more disaggregated base station units, such as a Near-Real Time (Near-RT) RAN Intelligent Controller (RIC) 164 via an E2 link, or a Non-Real Time (Non-RT) RIC 168 associated with a Service Management and Orchestration (SMO) Framework 166, or both. A CU 162 may communicate with one or more distributed units (DUs) 170 via respective midhaul links, such as an F1 interface. The DUs 170 may communicate with one or more radio units (RUs) 172 via respective fronthaul links. The RUs 172 may communicate with respective UEs 120 via one or more radio frequency (RF) access links. In some implementations, the UE 120 may be simultaneously served by multiple RUs 172.

Each of the units (i.e., CUs 162, DUs 170, RUs 172), as well as the Near-RT RICs 164, the Non-RT RICs 168 and the SMO Framework 166, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 162 may host one or more higher layer control functions. Such control functions may include the radio resource control (RRC), packet data convergence protocol (PDCP), service data adaptation protocol (SDAP), or the like. Each control function may be implemented with an interface configured to communicate signals with other control functions hosted by the CU 162. The CU 162 may be configured to handle user plane functionality (i.e., Central Unit-User Plane (CU-UP)), control plane functionality (i.e., Central Unit-Control Plane (CU-CP)), or a combination thereof. In some implementations, the CU 162 can be logically split into one or more CU-UP units and one or more CU-CP units. The CU-UP unit can communicate bidirectionally with the CU-CP unit via an interface, such as the E1 interface when implemented in an O-RAN configuration. The CU 162 can be implemented to communicate with DUs 170, as necessary, for network control and signaling.

The DU 170 may correspond to a logical unit that includes one or more base station functions to control the operation of one or more RUs 172. In some aspects, the DU 170 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 170 may further host one or more low PHY layers. Each layer (or module) may be implemented with an interface configured to communicate signals with other layers (and modules) hosted by the DU 170, or with the control functions hosted by the CU 162.

Lower-layer functionality may be implemented by one or more RUs 172. In some deployments, an RU 172, controlled by a DU 170, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 172 may be implemented to handle over the air (OTA) communication with one or more UEs 120. In some implementations, real-time and non-real-time aspects of control and user plane communication with the RU(s) 172 may be controlled by the corresponding DU 170. In some scenarios, this configuration may enable the DU(s) 170 and the CU 162 to be implemented in a cloud-based RAN architecture, such as a vRAN architecture.

The SMO Framework 166 may be configured to support RAN deployment and provisioning of non-virtualized and virtualized network elements. For non-virtualized network elements, the SMO Framework 166 may be configured to support the deployment of dedicated physical resources for RAN coverage requirements, which may be managed via an operations and maintenance interface (such as an O1 interface). For virtualized network elements, the SMO Framework 166 may be configured to interact with a cloud computing platform (such as an open cloud (O-Cloud) 176) to perform network element life cycle management (such as to instantiate virtualized network elements) via a cloud computing platform interface (such as an O2 interface). Such virtualized network elements can include, but are not limited to, CUs 162, DUs 170, RUs 172 and Near-RT RICs 164. In some implementations, the SMO Framework 166 may communicate with a hardware aspect of a 4G RAN, such as an open eNB (O-eNB) 174, via an O1 interface. Additionally, in some implementations, the SMO Framework 166 may communicate directly with one or more RUs 172 via an O1 interface. The SMO Framework 166 also may include a Non-RT RIC 168 configured to support functionality of the SMO Framework 166.

The Non-RT RIC 168 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 164. The Non-RT RIC 168 may be coupled to or communicate with (such as via an A1 interface) the Near-RT RIC 164. The Near-RT RIC 164 may be configured to include a logical function that enables near-real-time control and optimization of RAN elements and resources via data collection and actions over an interface (such as via an E2 interface) connecting one or more CUs 162, one or more DUs 170, or both, as well as an O-eNB, with the Near-RT RIC 164.

In some implementations, to generate AI/ML models to be deployed in the Near-RT RIC 164, the Non-RT RIC 168 may receive parameters or external enrichment information from external servers. Such information may be utilized by the Near-RT RIC 164 and may be received at the SMO Framework 166 or the Non-RT RIC 168 from non-network data sources or from network functions. In some examples, the Non-RT RIC 168 or the Near-RT RIC 164 may be configured to tune RAN behavior or performance. For example, the Non-RT RIC 168 may monitor long-term trends and patterns for performance and employ AI/ML models to perform corrective actions through the SMO Framework 166 (such as reconfiguration via O1) or via creation of RAN management policies (such as A1 policies).

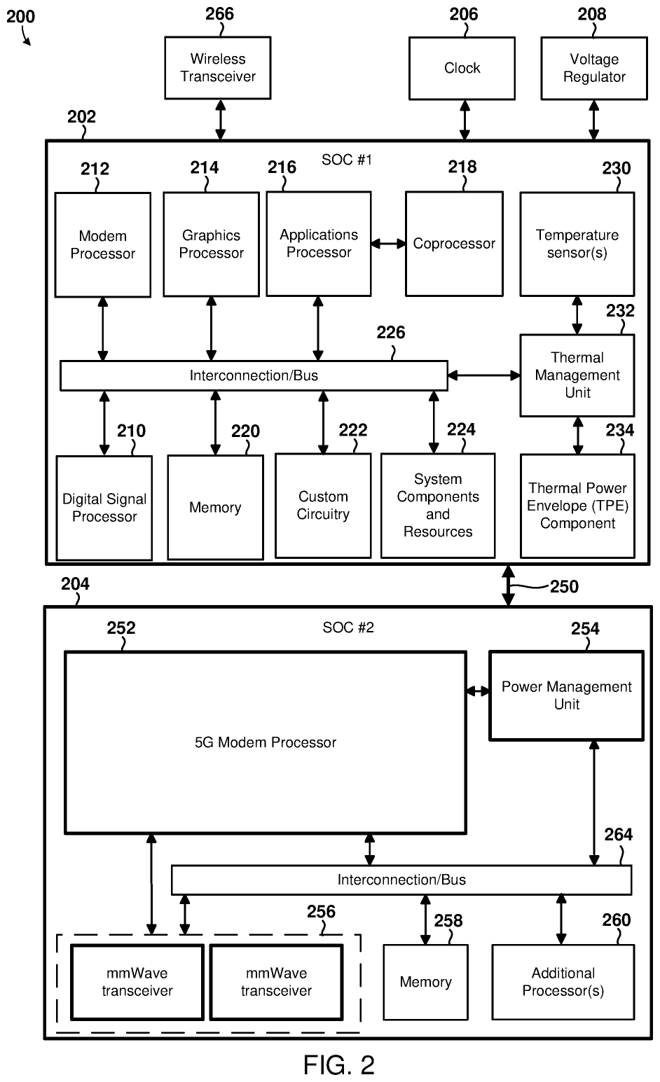

FIG. 2 is a component block diagram illustrating an example computing and wireless modem system 200 suitable for implementing any of the various embodiments. Various embodiments may be implemented on a number of single processor and multiprocessor computer systems, including a system-on-chip (SOC) or system in a package (SIP).

With reference to FIGS. 1A-2, the illustrated example computing system 200 (which may be a SIP in some embodiments) includes a two SOCs 202, 204 coupled to a clock 206, a voltage regulator 208, and a wireless transceiver 266 configured to send and receive wireless communications via an antenna (not shown) to/from a UE (e.g., 120a-120e) or a network device (e.g., 110a-110d). In some implementations, the first SOC 202 may operate as central processing unit (CPU) of the UE that carries out the instructions of software application programs by performing the arithmetic, logical, control and input/output (I/O) operations specified by the instructions. In some implementations, the second SOC 204 may operate as a specialized processing unit. For example, the second SOC 204 may operate as a specialized 5G processing unit responsible for managing high volume, high speed (such as 5 Gbps, etc.), and/or very high frequency short wave length (such as 28 GHz mmWave spectrum, etc.) communications.

The first SOC 202 may include a digital signal processor (DSP) 210, a modem processor 212, a graphics processor 214, an application processor 216, one or more coprocessors 218 (such as vector co-processor) connected to one or more of the processors, memory 220, custom circuitry 222, system components and resources 224, an interconnection/bus module 226, one or more temperature sensors 230, a thermal management unit 232, and a thermal power envelope (TPE) component 234. The second SOC 204 may include a 5G modem processor 252, a power management unit 254, an interconnection/bus module 264, a plurality of mmWave transceivers 256, memory 258, and various additional processors 260, such as an applications processor, packet processor, etc.

Each processor 210, 212, 214, 216, 218, 252, 260 may include one or more cores, and each processor/core may perform operations independent of the other processors/cores. For example, the first SOC 202 may include a processor that executes a first type of operating system (such as FreeBSD, LINUX, OS X, etc.) and a processor that executes a second type of operating system (such as MICROSOFT WINDOWS 10). In addition, any or all of the processors 210, 212, 214, 216, 218, 252, 260 may be included as part of a processor cluster architecture (such as a synchronous processor cluster architecture, an asynchronous or heterogeneous processor cluster architecture, etc.).

The first and second SOC 202, 204 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 224 of the first SOC 202 may include power amplifiers, voltage regulators, oscillators, phase-locked loops, peripheral bridges, data controllers, memory controllers, system controllers, access ports, timers, and other similar components used to support the processors and software clients running on a UE. The system components and resources 224 and/or custom circuitry 222 also may include circuitry to interface with peripheral devices, such as cameras, electronic displays, wireless communication devices, external memory chips, etc.

The first and second SOC 202, 204 may communicate via interconnection/bus module 250. The various processors 210, 212, 214, 216, 218, may be interconnected to one or more memory elements 220, system components and resources 224, and custom circuitry 222, and a thermal management unit 232 via an interconnection/bus module 226. Similarly, the processor 252 may be interconnected to the power management unit 254, the mmWave transceivers 256, memory 258, and various additional processors 260 via the interconnection/bus module 264. The interconnection/bus module 226, 250, 264 may include an array of reconfigurable logic gates and/or implement a bus architecture (such as CoreConnect, AMBA, etc.). Communications may be provided by advanced interconnects, such as high-performance networks-on chip (NoCs).

The first and/or second SOCs 202, 204 may further include an input/output module (not illustrated) for communicating with resources external to the SOC, such as a clock 206 and a voltage regulator 208. Resources external to the SOC (such as clock 206, voltage regulator 208) may be shared by two or more of the internal SOC processors/cores.

In addition to the example SIP 200 discussed above, some implementations may be implemented in a wide variety of computing systems, which may include a single processor, multiple processors, multicore processors, or any combination thereof.

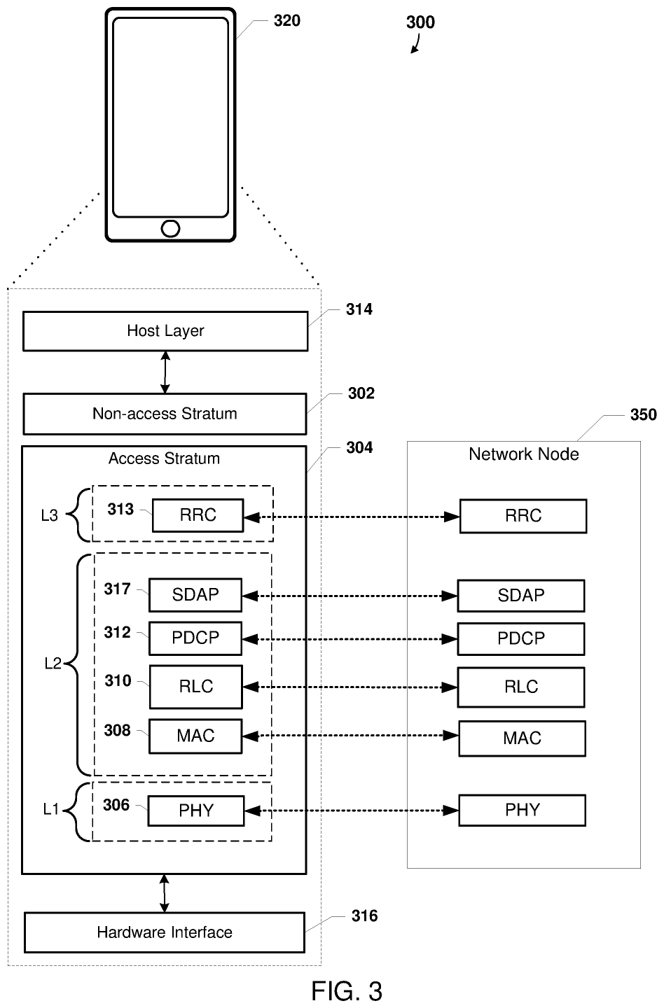

FIG. 3 is a component block diagram illustrating a software architecture 300 including a radio protocol stack for the user and control planes in wireless communications suitable for implementing any of the various embodiments.

With reference to FIGS. 1A-3, the UE 320 may implement the software architecture 300 to facilitate communication between a UE 320 (e.g., the UE 120a-120e, 200) and the network device 350 (e.g., the network device 110a-110d) of a communication system (e.g., 100). In various embodiments, layers in software architecture 300 may form logical connections with corresponding layers in software of the network device 350. The software architecture 300 may be distributed among one or more processors (e.g., the processors 212, 214, 216, 218, 252, 260). While illustrated with respect to one radio protocol stack, in a UE having a multi-subscriber identity module (SIM), the software architecture 300 may include multiple protocol stacks, each of which may be associated with a different SIM (e.g., two protocol stacks associated with two SIMs, respectively, in a dual-SIM wireless communication device). While described below with reference to LTE communication layers, the software architecture 300 may support any of variety of standards and protocols for wireless communications, and/or may include additional protocol stacks that support any of variety of standards and protocols wireless communications.

The software architecture 300 may include a Non-Access Stratum (NAS) 302 and an Access Stratum (AS) 304. The NAS 302 may include functions and protocols to support packet filtering, security management, mobility control, session management, and traffic and signaling between a SIM(s) of the UE (such as SIM(s) 204) and its core network 140. The AS 304 may include functions and protocols that support communication between a SIM(s) (such as SIM(s) 204) and entities of supported access networks (such as a network device, network node, RU, base station, etc.). In particular, the AS 304 may include at least three layers (Layer 1, Layer 2, and Layer 3), each of which may contain various sub-layers.

In the user and control planes, Layer 1 (L1) of the AS 304 may be a physical layer (PHY) 306, which may oversee functions that enable transmission and/or reception over the air interface via a wireless transceiver (e.g., 266). Examples of such physical layer 306 functions may include cyclic redundancy check (CRC) attachment, coding blocks, scrambling and descrambling, modulation and demodulation, signal measurements, MIMO, etc. The physical layer may include various logical channels, including the Physical Downlink Control Channel (PDCCH) and the Physical Downlink Shared Channel (PDSCH).

In the user and control planes, Layer 2 (L2) of the AS 304 may be responsible for the link between the UE 320 and the network node 350 over the physical layer 306. In some implementations, Layer 2 may include a media access control (MAC) sublayer 308, a radio link control (RLC) sublayer 310, and a packet data convergence protocol (PDCP) 312 sublayer, and a Service Data Adaptation Protocol (SDAP) 317 sublayer, each of which form logical connections terminating at the network node 350.

In the control plane, Layer 3 (L3) of the AS 304 may include a radio resource control (RRC) sublayer 3. While not shown, the software architecture 300 may include additional Layer 3 sublayers, as well as various upper layers above Layer 3. In some implementations, the RRC sublayer 313 may provide functions including broadcasting system information, paging, and establishing and releasing an RRC signaling connection between the UE 320 and the network node 350.

In various embodiments, the SDAP sublayer 317 may provide mapping between Quality of Service (QoS) flows and data radio bearers (DRBs). In some implementations, the PDCP sublayer 312 may provide uplink functions including multiplexing between different radio bearers and logical channels, sequence number addition, handover data handling, integrity protection, ciphering, and header compression. In the downlink, the PDCP sublayer 312 may provide functions that include in-sequence delivery of data packets, duplicate data packet detection, integrity validation, deciphering, and header decompression.

In the uplink, the RLC sublayer 310 may provide segmentation and concatenation of upper layer data packets, retransmission of lost data packets, and Automatic Repeat Request (ARQ). In the downlink, while the RLC sublayer 310 functions may include reordering of data packets to compensate for out-of-order reception, reassembly of upper layer data packets, and ARQ.

In the uplink, MAC sublayer 308 may provide functions including multiplexing between logical and transport channels, random access procedure, logical channel priority, and hybrid-ARQ (HARQ) operations. In the downlink, the MAC layer functions may include channel mapping within a cell, de-multiplexing, discontinuous reception (DRX), and HARQ operations.

While the software architecture 300 may provide functions to transmit data through physical media, the software architecture 300 may further include at least one host layer 314 to provide data transfer services to various applications in the UE 320. In some implementations, application-specific functions provided by the at least one host layer 314 may provide an interface between the software architecture and the general purpose processor (e.g., 202).

In other implementations, the software architecture 300 may include one or more higher logical layer (such as transport, session, presentation, application, etc.) that provide host layer functions. For example, in some implementations, the software architecture 300 may include a network layer (such as Internet Protocol (IP) layer) in which a logical connection terminates at a packet data network (PDN) gateway (PGW). In some implementations, the software architecture 300 may include an application layer in which a logical connection terminates at another device (such as end user device, server, etc.). In some implementations, the software architecture 300 may further include in the AS 304 a hardware interface 316 between the physical layer 306 and the communication hardware (such as one or more radio frequency (RF) transceivers).

In various network implementations or architectures, in the network device 350 the different logical layers 308-317 may be implemented in an aggregated or monolithic base station architecture, or alternatively, in a disaggregated network device architecture, and various logical layers may implemented in one or more of a CU, a DU, an RU, a Near-RT RAN Intelligent Controller (RIC), or a Non-Real Time (Non-RT) RIC. Further, the network device 350 may be implemented as an aggregated base station, as a disaggregated base station, an integrated access and backhaul (IAB) node, a relay node, a sidelink node, etc.

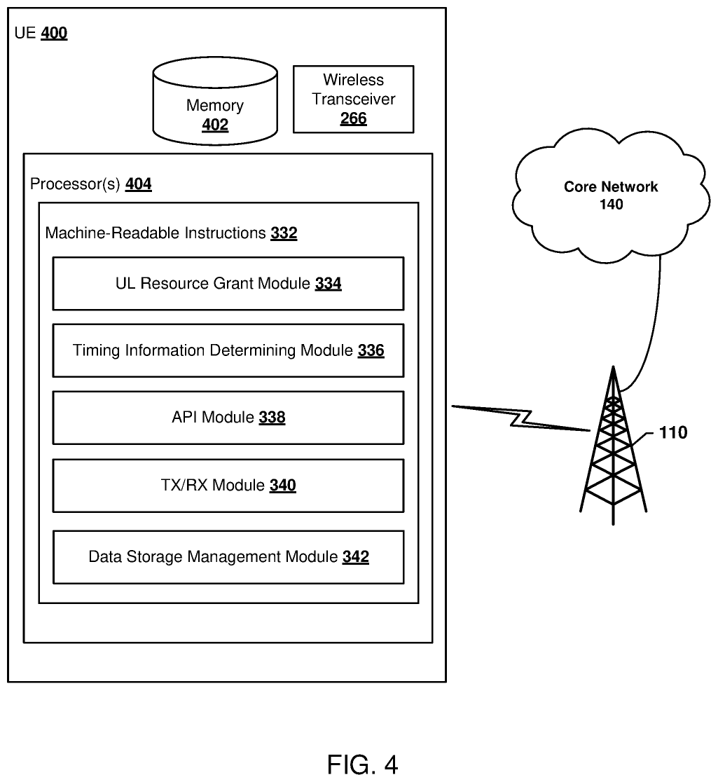

FIG. 4 is a component block diagram illustrating elements of a UE 400 configured in accordance with various embodiments. With reference to FIGS. 1A-4, the UE 400 (e.g., 120a-120e, 320) may be configured to communicate with a core network 140 via a base station 110.

The UE 400 may include one or more processors 404, memory 402, a wireless transceiver 266, and other components. The UE 400 may include a plurality of hardware, software, and/or firmware components operating together to provide the functionality attributed herein to the processor(s) 404.

The memory 402 may include non-transitory storage media that electronically stores information. The electronic storage media of memory 402 may include one or both of system storage that is provided integrally (i.e., substantially non-removable) with the vehicle processing system 104 and/or removable storage that is removably connectable to the UE 400 via, for example, a port (e.g., a universal serial bus (USB) port, a firewire port, etc.) or a drive (e.g., a disk drive, etc.). In various embodiments, memory 402 may include one or more of electrical charge-based storage media (e.g., EEPROM, RAM, etc.), solid-state storage media (e.g., flash drive, etc.), optically readable storage media (e.g., optical disks, etc.), magnetically readable storage media (e.g., magnetic tape, magnetic hard drive, floppy drive, etc.), and/or other electronically readable storage media.

The memory 402 may include one or more virtual storage resources (e.g., cloud storage, a virtual private network, and/or other virtual storage resources). Memory 402 may store software algorithms, information determined by processor(s) 404, information received from another UE, from a network element of the core network 140, information received from the base station 110, and/or other information that enables the UE 400 to function as described herein.

The processor(s) 404 may include one of more local processors that may be configured to provide information processing capabilities in the UE 400. As such, the processor(s) 404 may include one or more of a digital processor, an analog processor, a digital circuit designed to process information, an analog circuit designed to process information, a state machine, and/or other mechanisms for electronically processing information. Although the processor 404 is shown in FIG. 4 as a single entity, this is for illustrative purposes only. In some embodiments, the processor(s) 404 may include a plurality of processing units. These processing units may be physically located within the same device, or the processor(s) 404 may represent processing functionality of a plurality of devices distributed in the vehicle and operating in coordination.

The processor(s) 404 may be configured by machine-readable instructions 432, which may include one or more instruction modules. The instruction modules may include computer program modules. In various embodiments, the instruction modules may include one or more of an UL resource grant module 434, a timing information determining module 436, an API module 438, a transmit/receive (TX/RX) module 440, data storage management module 442, and/or other modules.

The UL resource grant module 434 may be configured to receive uplink resource grant timing information from a radio access network (RAN), the uplink resource grant timing information indicating an uplink transmission opportunity.

The timing information determining module 436 may be configured to determine uplink resource grant timing information. The uplink resource grant timing information may include an uplink period and an offset value within the uplink period that enables the application to send the data to the modem for transmission to the RAN during the uplink transmission opportunity. The timing information determining module 436 may be configured to receive the uplink resource grant timing information via radio resource control (RRC) signaling. The timing information determining module 436 may be configured to receive an indication of an uplink period via RRC signaling and receiving a downlink control information (DCI) that indicates an offset value within the uplink period. The timing information determining module 436 may be configured to receive uplink grants in a DCI in a pattern that indicates an uplink period and an offset within the uplink period.

The timing information determining module 436 may be configured to provide the uplink resource grant timing information to an application executing in a processor of the UE. The timing information determining module 436 may be configured to monitor the arrival of one or more data flows from the application, and to determine whether an arrival time of the data flow at the modem meets a timing drift threshold from the uplink resource grant timing information.

The API module 438 may be configured to execute an API enabling communication between an application executing in the UE 400 and a modem of the UE 400. The API module 438 may be configured to receive, from the application, data for transmission to the RAN during the uplink transmission opportunity. The API module 330 may be configured to receive data from one or more data flows from the application.

The TX/RX module 442 may be configured to transmit the data from one or more data flows to the RAN during the uplink transmission opportunity, as well as to transmit or receive various information from the RAN and/or the core network. The TX/RX module 442 may be configured to transmit an uplink transmission request associated with application data. The TX/RX module 442 may be configured to receive information related to periodic uplink resource grants, resource grants responsive to uplink transmission requests (e.g., scheduling request, buffer status report, and the like), and other suitable signaling or information.

The data storage management module 442 may be configured to store data from one or more data flows for later transmission to the core network 140 via the base station 110. The data storage management module 442 may be configured to receive, from the application (e.g., via the API module 438), an indication that it is permissible to store the application data.

The processor(s) 404 may be configured to execute the modules 434-442 and/or other modules by software, hardware, firmware, some combination of software, hardware, and/or firmware, and/or other mechanisms for configuring processing capabilities on processor(s) 404.

The description of the functionality provided by the different modules 434-442 is for illustrative purposes, and is not intended to be limiting, as any of modules 434-442 may provide more or less functionality than is described. For example, one or more of modules 434-442 may be eliminated, and some or all of its functionality may be provided by other ones of modules 434-442. As another example, processor(s) 404 may be configured to execute one or more additional modules that may perform some or all of the functionality attributed below to one of modules 434-442.

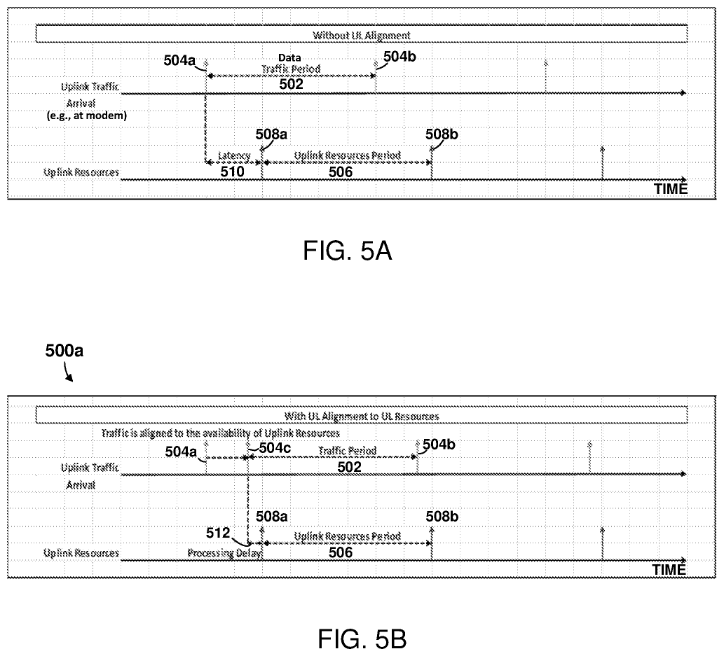

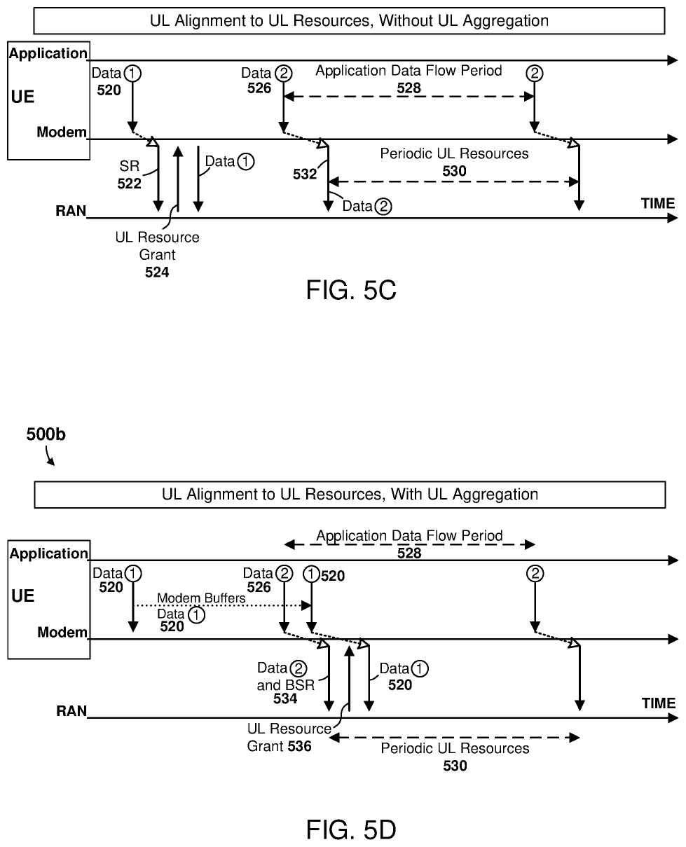

FIG. 5A is a timeline diagram illustrating the transmission of uplink data by a UE without alignment of the data transmission with granted uplink resources. FIG. 5B is a timeline diagram illustrating a method 500a of uplink data transmission in accordance with various embodiments. In the method 500a, the UE may align data for uplink transmission with granted uplink resources.

With reference to FIGS. 1A-5B, the operations of the method 500a may be performed by a processor (such as the processor 210, 212, 214, 216, 218, 252, 260, 404) of a UE (such as the UE 120a-120e, 200, 320, 400).

Referring to FIG. 5A, uplink traffic that is not aligned to an uplink transmission opportunity may be subject to delay, causing latency in data communications. For example, data for uplink transmission to a RAN may arrive at a modem from time to time, such as data arrival times 504a, 504b according to a data traffic period 502. Uplink transmission resources for use by the UE to transmit the data may be available from time to time according to an uplink resources period 506, such as at uplink transmission opportunities 508a, 508b, etc. Data arriving at time 504a cannot be transmitted to the RAN until uplink transmission opportunity 508a, causing a period of latency 510.

Referring to FIG. 5B, aligning uplink data with an uplink transmission opportunities decreases latency, as the data for transmission arrives closer in time to the uplink transmission opportunity. In some embodiments, the data may arrive at a time sufficiently before the uplink transmission opportunity to enable the modem to process the data for transmission to the RAN. For example, the modem and/or the application may be configured to perform operations such that data that would otherwise arrive at the modem at arrival time 504a may instead arrive at arrival time 504c. Data arrival time 504c may still be prior to uplink transmission opportunity 508a, to enable the modem processing time 512 (a small processing delay) to process the data for uplink transmission. Typically, the modem processing time 512 is substantially shorter than latency 510.

FIG. 5C is a timeline diagram illustrating transmission of uplink data by a UE without aggregation of data from different data flows. FIG. 5D is a timeline diagram illustrating a method 500b of uplink data transmission in accordance with various embodiments. In the method 500b, the UE may transmit uplink data aligned with granted uplink resources. With reference to FIGS. 1A-5D, the operations of the method 500b may be performed by a processor (such as the processor 210, 212, 214, 216, 218, 252, 260, 404) of a UE (such as the UE 120a-120e, 200, 320, 400).

Referring to FIG. 5C, some data that an application sends to a modem for uplink transmission, such as first data 520, may arrive at a time when uplink resources, such as periodic uplink resources, are not available. The arrival of the first data 520 at the modem may trigger the modem to send a scheduling request (SR) 522 to the RAN. The RAN may respond with an uplink resource grant 524 providing to the UE uplink communication link resources for the first data 520. The modem may then transmit the data 522 the RAN. At a later time, the application may send second data 526 to the modem, and the modem may transmit the second data 526 using a periodic uplink transmission opportunity 532, which the RAN may grant to the UE from time to time according to an uplink resources period 530. In some embodiments, the application may send the second data 526 to the modem from time to time according to an application data flow period 528.

Referring to FIG. 5D, in some embodiments, when first data 520 arrives at a time when uplink resources are not available, the modem may buffer (store in memory) the first data until an uplink transmission opportunity, such as a periodic uplink opportunity, is available. At a later time, the application may send to the modem the second data 526 and an uplink transmission request, such as a buffer status report (BSR) 534, which may indicate to the RAN the UE has the first data 524 ready for transmission to the RAN. The RAN may respond to the uplink transmission request with an uplink resource grant 536. The UE may transmit the first data 520 using the granted uplink resources. By aggregating the uplink transmissions of the first data 520 and the second data 526, the UE may reduce the use of communication link resources, as well as save power by avoiding transmitting the scheduling request 522, receiving the granted uplink resources 524, and transmitting the first data 520, outside of the availability of periodic uplink resources. In some embodiments, while delaying the transmission of the first data 520 may increase latency of the first data 520, the UE may benefit by saving power, and the communication system may benefit from the reduced use of communication link resources.

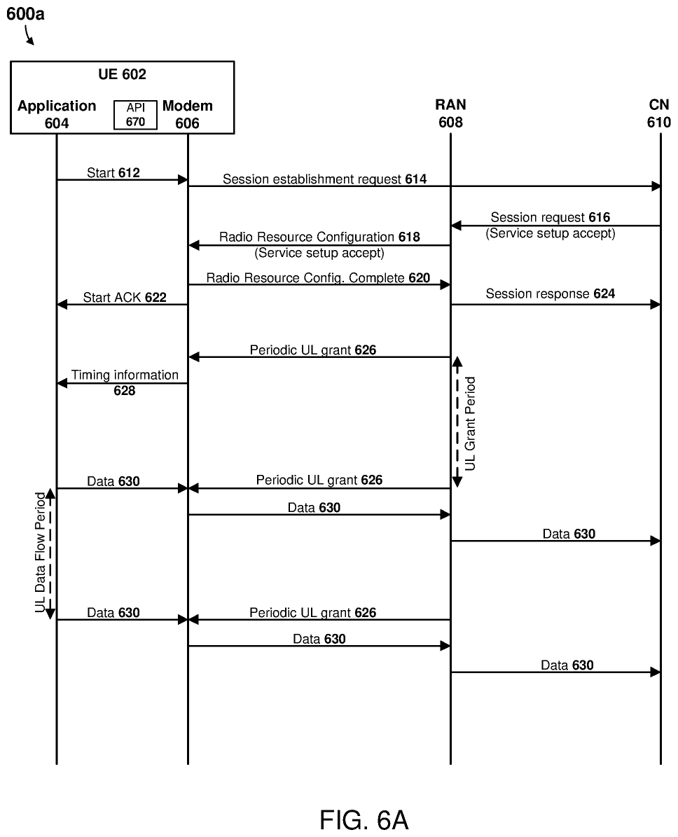

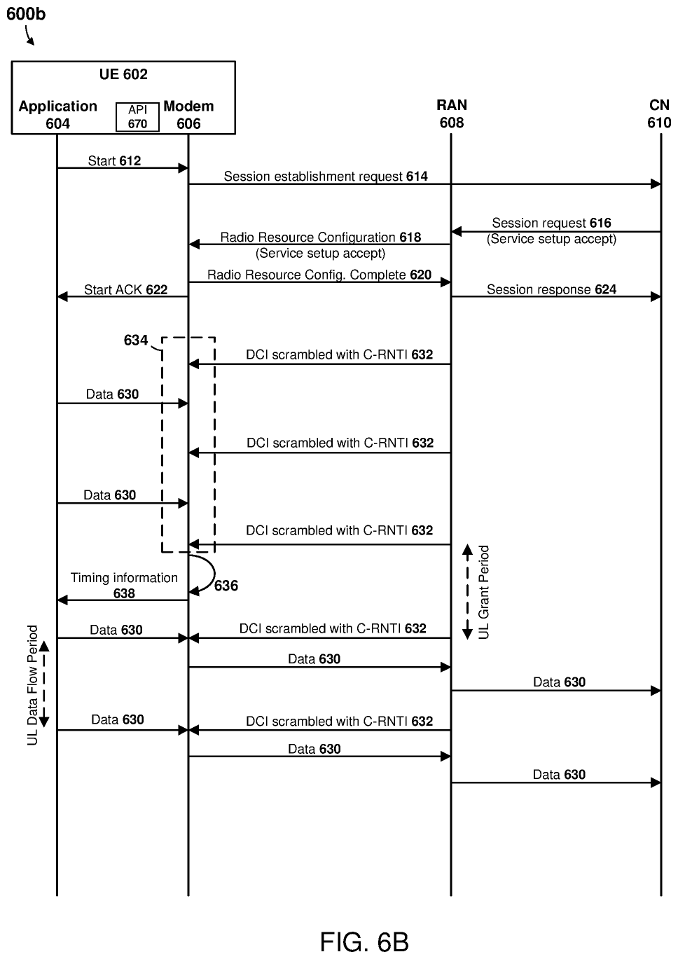

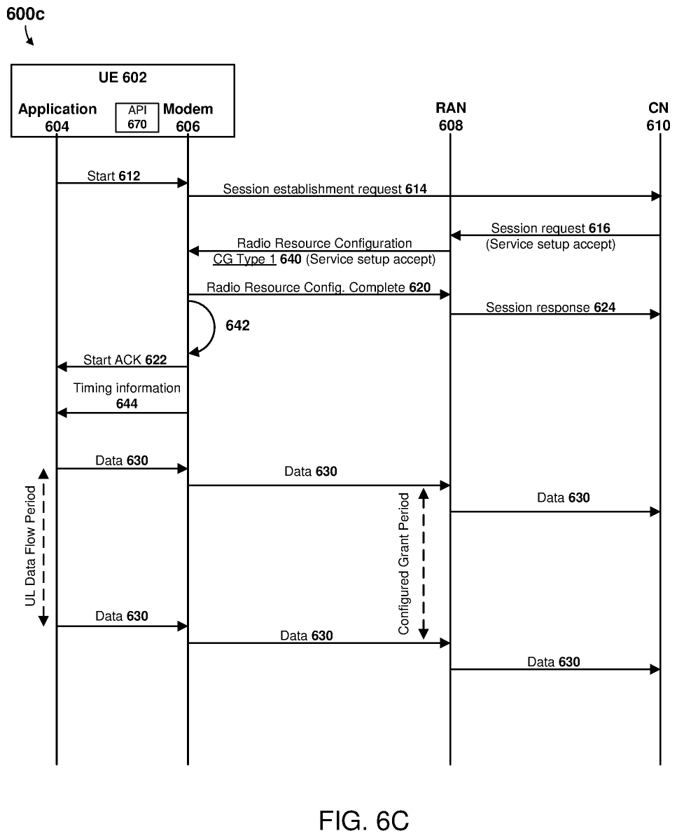

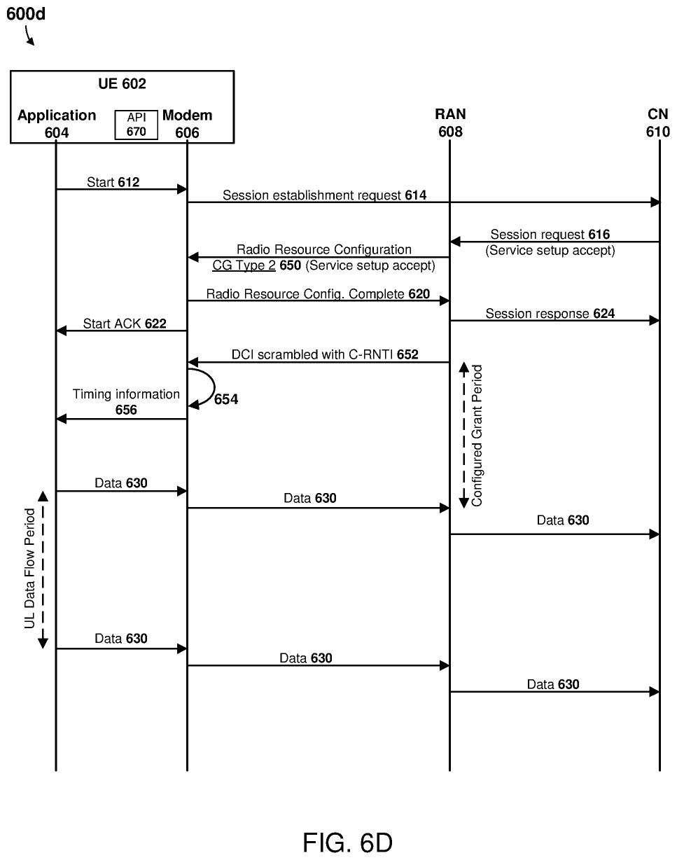

FIGS. 6A-6D are data flow diagrams illustrating methods 600a, 600b, 600c, and 600d for uplink data transmission according to various embodiments. In various embodiments, one or more processors (e.g., a processing system) of a UE may perform operations of the methods 600a-600d to align uplink data transmission with periodic grants of uplink transmission opportunities. With reference to FIGS. 1A-6D, operations of the methods 600a-600d may be performed by a processor (such as the processor 210, 212, 214, 216, 218, 252, 260, 404) of a UE (such as the UE 120a-120e, 200, 320, 400), as well as by a processor of a RAN 608 and a processor of a network element of a core network 610.

The UE 602, including an application 604 executing in a processor and a modem 606, the RAN 608, and the core network (CN) 610 may perform operations to establish a session for the application 604 executing on the UE and to provide data communication link resources to the UE 602. The application 604 may begin executing in a processor of the UE 602, and may send a start message 612 to the modem 606. Responsive to the start message 612, the modem may send a session establishment request 614 to a network element (e.g., a server that supports the application or otherwise interacts with the application) in the core network 610 via the RAN 608. The core network 610 (i.e., the network element) may send a session request message 616 to the RAN indicating service set up acceptance, and providing configuration information to the RAN 608, including a quality of service (QoS) profile of the data traffic associated with data to be received from the application 604. The RAN 608 may perform operations to configure radio resources for the UE 602, and may send a Radio Resource Configuration (RRC) message 618 to the modem 606. In some embodiments, the RAN 608 may identify a periodic nature of anticipated uplink traffic from the UE 602, and use the identified periodic nature of the anticipated uplink traffic to configure radio resources appropriately. In some embodiments, the modem 606 may provide total or complete configuration and timing information to the application 604 in the message 622. In some embodiments, the modem 606 may provide partial or incomplete configuration and timing information 628. In some embodiments, the modem may update timing information 628 from time to time.

The modem 606 of the UE may perform operations to use radio resources configured according to the RRC message 618, and may respond to the RAN 608 with an RRC configuration complete message 622. The modem may send a start acknowledgment message 622 to the application 604 indicating the application may provide uplink data to the modem for transmission to the RAN. The RAN 608 may send a session response message 624 to the network element of the core network 610.

From time to time, the RAN 608 may provide a periodic uplink grant 626 of uplink transmission opportunities. In some embodiments, as noted above, the modem 606 may provide timing information 628 about the periodic uplink grants 626 to the application 604. Using the timing information 628, the application 604 may send data 630 to the modem 606 close in time to an uplink transmission opportunity according to the periodic uplink grant 626. The modem 606 may transmit the data 630 to the RAN 608 during the uplink transmission opportunity. The RAN 608 may convey the data 632 the core network 610. Using the timing information 628, the UE 602 (e.g., the application 604 and/or the modem 606) may substantially align the arrival of the data 630 at the modem 606 with the uplink transmission opportunity provided by the periodic uplink grant 626 of uplink medication resources.

In some embodiments, the modem 606 may be configured with an API 670 that enables the application 604 to align the delivery of the data 630 with the uplink transmission opportunities provided by the periodic uplink grants 626. In some embodiments, the API 670 may provide the timing information 628 to the application 604. In some embodiments, the timing information 628 may include information about the uplink grant period. In some embodiments, the timing information 628 may include an offset value within the uplink grant period. In some embodiments, the timing information 628 (e.g., the uplink grant period and/or the offset value) may be signaled explicitly by the RAN 608. In some embodiments, the UE 602 may determine one or more aspects of the timing information 628, such as the uplink grant period and/or the offset value, from an aspect of the periodic uplink grants, without explicit signaling from the RAN 608 (which may be referred to as implicit signaling). In various embodiments, information about the periodic grant of uplink resources (periodic uplink grants) that provide uplink transmission opportunities may be provided to the UE, or determined by the UE, in a Dynamic Grant, a Configured Grant (CG) Type 1, or a CG Type 2, as further described below.

Referring to FIG. 6B, in some embodiments, periodic uplink grants may be provided by a Dynamic Grant. In some embodiments, RAN 608 may send uplink grants periodically via (using, in) a DCI scrambled with a C-RNTI 632. In some embodiments, the UE may apply an algorithm (which may be a proprietary algorithm) to determine (identify) a periodic pattern based on uplink grants received by the UE 602 in the DCI scrambled with the C-RNTI 632. For example, the UE 602 may identify a periodic timing by which the UE 602 receives certain uplink grants having a similar Transport Block Size. In some embodiments, the modem 606 may receive a plurality of DCIs scrambled with a C-RNTI 632 during a period of time 634. In some embodiments, the period of time 634 may be defined by the reception of two, three, or more DCIs scrambled with a C-RNTI 632 by the modem 606. Based on the arrival of the DCIs scrambled with a C-RNTI 632 during the period of time 634, the modem 606 may determine 636 timing information 638 about the uplink transmission opportunities (e.g., uplink period and/or offset value) and may send the timing information 638 to the application 604. The application 604 may send the data 630 to the modem 606 according to the timing information 638, close in time to an uplink transmission opportunity (i.e., availability of uplink communication link resources).

Referring to FIG. 6C, in various embodiments, periodic uplink grants may be provided by a Configured Grant Type 1. In some embodiments, the RAN 608 may send to the modem 606 a Radio Resource Configuration message including a CG Type 1 640 configuration information. The CG Type 1 640 configuration information may include an uplink period and an offset value within the uplink period.

The modem 606 may identify (determine) 642 timing information from the CG type 1 that identifies the periodic grants from the CG type 1 configuration information (e.g., uplink period and the offset value). The modem 606 may send timing information 644 to the application 604, which may enable the application 604 to align data flows 630 with periodic uplink transmission opportunities. The application 604 may send the data 630 to the modem 606 according to the timing information 644, close in time to an uplink transmission opportunity (i.e., availability of uplink communication link resources). The modem 606 may transmit the data 630 to the RAN 608 using the radio resources configured by the CG Type 1 configuration information.

Referring to FIG. 6D, in some embodiments, periodic uplink grants may be provided by a Configured Grant Type 2. In such embodiments, the RAN 608 may send to the modem 606 a Radio Resource Configuration message including a CG Type 2 650 configuration information. The CG Type 1 650 configuration information may include an uplink period, but may not include an offset value within the uplink period. The RAN 608 may later transmit a DCI scrambled by an CS-RNTI 652 (e.g., DCI format 0_1). The modem 606 may determine 654 the offset value based on the timing of the arrival of the DCI scrambled by the CS-RNTI 652, such as a slot in which the modem 606 receives the DCI scrambled by the CS-RNTI 652. In this manner, the RAN 608 may provide to the modem 606 the configured grant period in the CG Type 2 configuration information, and may indicate the offset value by the timing of the transmission of the DCI scrambled by the CS-RNTI 652.

The modem 606 may report (send) timing information 656, including the uplink period and the offset value, to the application 604. The application 604 may then send the data 630 to the modem 606 according to the timing information 656, close in time to an uplink transmission opportunity (i.e., availability of uplink communication link resources). The modem 606 may transmit the data 630 to the RAN 608 using the radio resources configured by the CG Type 2 configuration information.

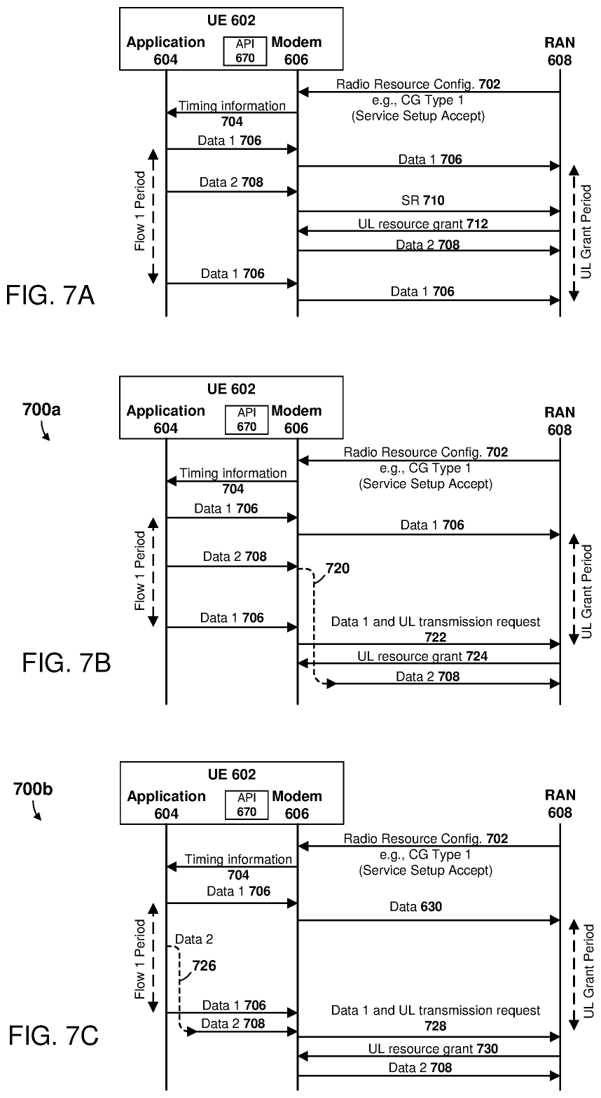

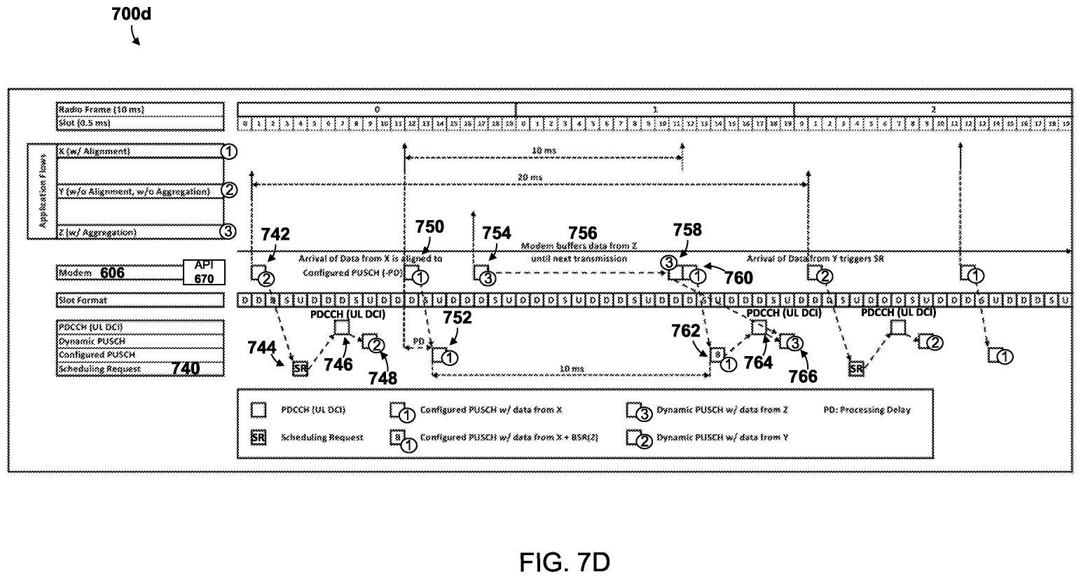

FIG. 7A is a data flow diagram illustrating the transmission of uplink data by a UE without aggregation of data from different data flows. FIGS. 7B and 7C are data flow diagrams illustrating methods 700a and 700b of uplink data transmission in accordance with various embodiments. In the methods 700a and 700b, the UE 602 may transmit uplink data with aggregation of data from two or more data flows using granted uplink resources. With reference to FIGS. 1A-7C, the operations of the methods 700a and 700b may be performed by a processor (such as the processor 210, 212, 214, 216, 218, 252, 260, 404) of a UE (such as the UE 120a-120e, 200, 320, 400).

Referring to FIG. 7A, some data that the application 604 sends to the modem 606 for uplink transmission, such as Data 2 520, may arrive at a time when uplink resources, such as periodic uplink resources, are not available. For example, the RAN 608 may transmit Radio Resource Configuration information 702 to the modem 606, and the modem 606 may determine timing information about periodic availability of uplink transmission opportunities (e.g., an uplink grant period). The modem 606 may provide timing information 704 (e.g., the uplink period and an offset value) to the application 604. Using the timing information 704, the application 604 may send Data 1 706 to the modem 606 for transmission to the RAN 608.

The arrival of Data 2 708 at the modem 606 from the application 604 may trigger the modem 606 to send a scheduling request (SR) 710 to the RAN 608. The RAN 608 may respond with an uplink (UL) resource grant 712 providing to the UE 602 uplink communication link resources for Data 2 708. The modem 606 may then transmit the Data 2 708 to the RAN 608. At a later time, when periodic uplink resources are again available, the application 604 may send Data 1 706 to the modem 606, and the modem 606 may transmit the Data 1 706 to the RAN 608 during the next periodic uplink transmission opportunity.

Referring to FIG. 7B, the modem 606 may be configured to perform operations for aggregation of different data aggregation flows. In some embodiments, upon arrival of Data 2 708, the modem 606 may buffer (store) 720 the Data 2 until a later time. Using the timing information 704, the application 604 may send Data 1 706 to the modem 606 for transmission to the RAN 608. The modem 606 may send to the RAN 608 the Data 1 and an uplink transmission request 722 for Data 2 708. The RAN 608 may respond with an uplink resource grant 724 for Data 2. The modem 606 may send the Data 2 708 to the RAN 608 using the uplink resources granted in the uplink resource grant 724. In such embodiments, the modem 606 may transmit fewer scheduling requests, enabling the UE 602 to save power. Further, in such embodiments, the modem 606 may not change an operating mode of the UE 602 from a low-power mode, such as a discontinuous reception (DRX) sleep mode (e.g., “wake up” the UE 602), to transmit a scheduling request for Data 2 and the Data 2 itself. In some embodiments, the modem 606 may aggregate data flows using various information associated with a data flow, for example, QoS flow levels of different data flows (e.g., before Service Data Adaptation Protocol (SDAP) handling of a data flow), a Radio Bearer level of different data flows (e.g., before Packet Data Convergence Protocol (PDCP) handling of a data flow, e.g., to an upper layer), a Radio Link Control (RLC) channel level of different data flows (e.g., before RLC handling of a data flow), and/or other information. Aggregating a data flow before SDAP, PDCP, or RLC handling of the data flow may enable delaying a time at which the data flow is delivered, e.g., to a lower layer, or for transmission.

Referring to FIG. 7C, the application 604 may be configured to perform operations for aggregation of different data aggregation flows. For example, using the timing information 704, the application 604 may generate Data 2 at a time when the uplink transmission opportunity is not available. The application 604 may buffer (store) 726 Data 2 until a later time, such as just prior to an uplink transmission opportunity (e.g., based on the timing information 704), at which time the application 604 may send to the Data 1 706 and the Data 2 708 to the modem 606 for transmission.

In response, the modem 606 may send to the RAN 608 the Data 1 and an uplink transmission request 728 for Data 2 708. The RAN 608 may respond with an uplink resource grant 730 for Data 2. The modem 606 may send the Data 2 708 to the RAN 608 using the uplink resources granted in the uplink resource grant 730. In such embodiments, the data flow aggregation of Data 1 and Data 2 performed by the application 604 may be transparent to the modem 606, that is the modem 606 may be unaware of the data flow aggregation operations performed by the application 604.

FIG. 7D is a timing diagram 700d illustrating timing of various messages and data transmissions and receptions of different application data flows by a modem of a UE according to various embodiments. With reference to FIGS. 1A-7D, various embodiment methods may include aggregation of data flows, alignment of data flows, and/or neither alignment nor aggregation of data flows as illustrated.

As noted above, the modem 606 may be configured with an API 670 enabling communication about data flows and uplink resource grant timing information to be communicated between the modem 606 and an application executing in a processor of the UE (e.g., the application 604). In some embodiments, the modem 606 and the API 670 may be configured to identify and process three different types of data flows: flows that are aligned to periodic uplink resource grants (illustrated as flow type 1); flows that are neither aligned to periodic uplink resource grants nor aggregated with other flows (illustrated as flow type 2); and flows that are permitted to be aggregated (may be aggregated) with other data flows (illustrated as flow type 3). In various embodiments, the modem 606 may be configured to send a scheduling request 740 in response to receiving a flow type 2 that is neither aligned to periodic uplink resource grants nor aggregated with other data flows. However, the modem 606 may not be configured to send a scheduling request 740 in response to receiving a flow type 1 or a flow type 3.

For example, in response to receiving data of a flow type 2 742, which is not aligned with an uplink transmission opportunity nor is aggregated with another dataflow, the modem 606 may transmit a scheduling request 744 to request a grant of uplink resources for the flow type 2 data 742. The modem 606 may receive an uplink resource grant in a Physical Downlink Control Channel message (PDCCH) 746, and using the granted uplink resources may transmit the flow type 2 data 748.

As another example, in response to receiving data of a flow type 1 750, which may be aligned to an uplink transmission opportunity, after a brief processing delay (PD) during which the modem 606 may process the data of flow type 1 750 for transmission, the modem 606 may transmit the flow type 1 data 752.

As another example, in response to receiving data of a flow type 3 754, which is permitted to be aggregated with other data flows, the modem 606 may buffer 756 the flow type 3 data until a next uplink transmission opportunity 758. The modem 606 may receive data of a flow type 1 760, which is aligned with the uplink transmission opportunity. The modem 606 may transmit the flow type 1 data with an uplink transmission request 762, such as a buffer status report, related to the flow type 3 data 758. The modem 606 may receive an uplink resource grant in a PDCCH 764, and using the granted uplink resources may transmit the flow type 3 data 766.

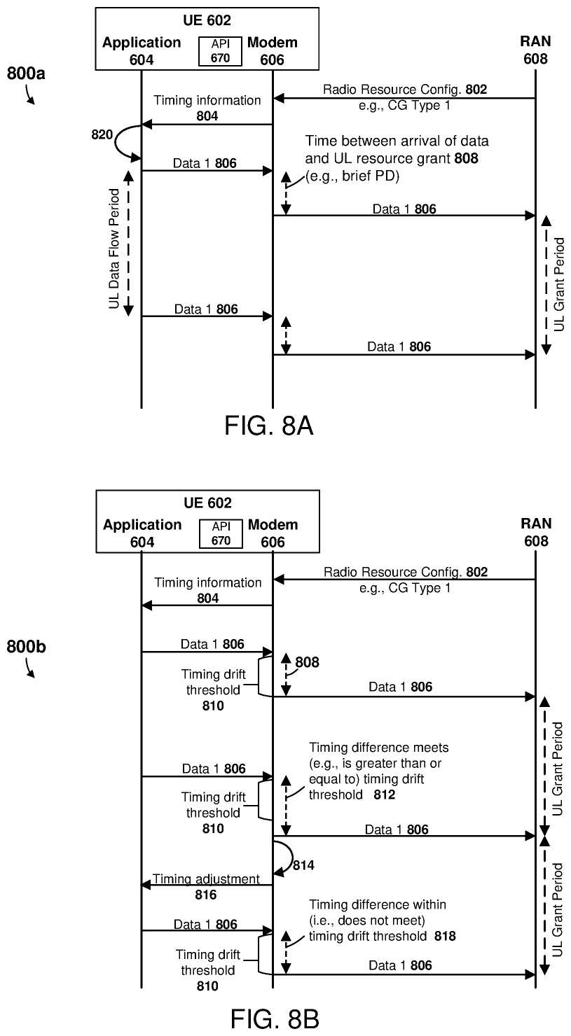

FIGS. 8A and 8B are data flow diagrams illustrating methods 800a and 800b for uplink data transmission in accordance with various embodiments. With reference to FIGS. 1A-8B, the operations of the methods 800a and 800b may be performed by a processor (such as the processor 210, 212, 214, 216, 218, 252, 260, 404) of a UE (such as the UE 120a-120e, 200, 320, 400).

As noted above, the modem 606 may be configured with an API 670 enabling communication about data flows and uplink resource grant timing information to be communicated between the modem 606 and an application executing in a processor of the UE (e.g., the application 604). In some embodiments, the uplink resource grant timing information may or may not have slot-level accuracy. In some embodiments, the application executing in the UE may be capable of determining accurate timing of uplink resource grants. In some embodiments, the application executing in the UE may not be capable of determining accurate uplink resource grant timing.

Referring to FIG. 8A, the API 670 may be configured as a semi-static API. In some embodiments, a semi-static API may be suitable for use with an application capable of determining accurate timing of uplink resource grants. For example, in some embodiments, the RAN 608 may transmit RRC configuration information 802 to the modem 606. The modem 606 may determine timing information and provide the timing information 804 to the application 604. In some embodiments, the timing information 804 may include an uplink resource grant and an offset value. In some embodiments, the offset value provided they the application 606 enables of the application 606 to account for a brief processing delay required by the modem 6062 process data for transmission to the RAN 608 (for example, time required to build a Transport Block). In some embodiments, the modem 606 may provide the timing information 804 to the application 604 only once, because the application 604 is capable of determining accurate timing of uplink resource grants.

Using the timing information 804, the application 604 may determine (select) the uplink resource grant period, and may send Data 1 806 to the modem 606 at a time close to a next or upcoming uplink transmission opportunity (e.g., according to the availability of periodic uplink resources). The application 604 may send the Data 1 806 at a time 808 prior to the uplink transmission opportunity, for example, based on the offset value in the timing information 804. The modem 606 may send the Data 1 806 to the RAN 608.

In some embodiments, using the timing information 804, the application 604 may select data flows (e.g., Data 1) to be aligned with uplink transmission opportunities and may transmit data from the selected data flows to the modem 606 without receiving further timing information from the modem 606. Further, the application 604 may not provide a signal or indication to the modem 606 identifying data flows for alignment with uplink transmission opportunities. In some embodiments, the modem 606 may provide the uplink resource grant period and the offset value to the application 604 in response to the modem 606 identifying periodic grants (e.g., determining timing information such as the uplink resource grant period and/or offset value based on configuration information from the RAN 608).

Referring to FIG. 8B, In some embodiments the API 670 may be configured as a dynamic API. A dynamic API may be suitable for use with an application that is not capable of determining accurate timing of uplink resource grants. Because of its timing and accuracy, the timing by which the application 604 may provide Data 1 806 to the modem 606 may vary over time (e.g., drift), and may become increasingly misaligned with periodic uplink transmission opportunities. In some embodiments, the application 604 may signal or indicate to the modem 606 (e.g., via the API 670) an identification of a data flow that may require a timing adjustment, which may enable the modem 606 to track the timing of data flows that require a timing adjustment. In such embodiments, the modem 606 may monitor the arrival time of data from the indicated or identified data flows, and the modem 606 may determine whether the data arrives at a time that meets a timing drift threshold 810 compared to the uplink resource grant timing information 804 (e.g., from an upcoming uplink transmission opportunity).

For example, Data 1 806 may arrive at a time at which the timing difference meets 812 (e.g., is greater than or equal to) the timing drift threshold 810. In response to determining that the timing of the arrival of Data 1 meets the timing drift threshold 810, the modem 606 may determine (select) 814 a timing adjustment that may enable the application 604 to adjust (e.g., increase or decrease) the timing by which the application 604 sends Data 1 806 to the modem 606. The modem 606 may provide the timing adjustment 816 to the application 604. Using the timing adjustment, the application 604 may send Data 1 806 at a time such that the difference 818 between the arrival of Data 1 806 at the modem 606 and the uplink resource grant timing information 804 (e.g., upcoming uplink transmission opportunity) is within (i.e., does not meet) the timing drift threshold 810.

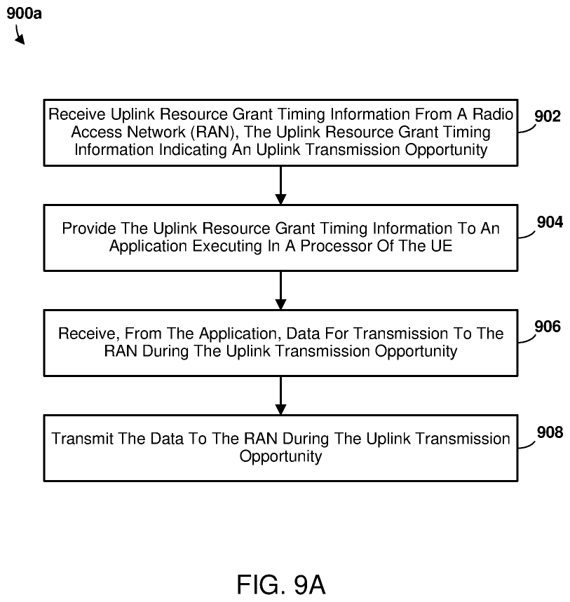

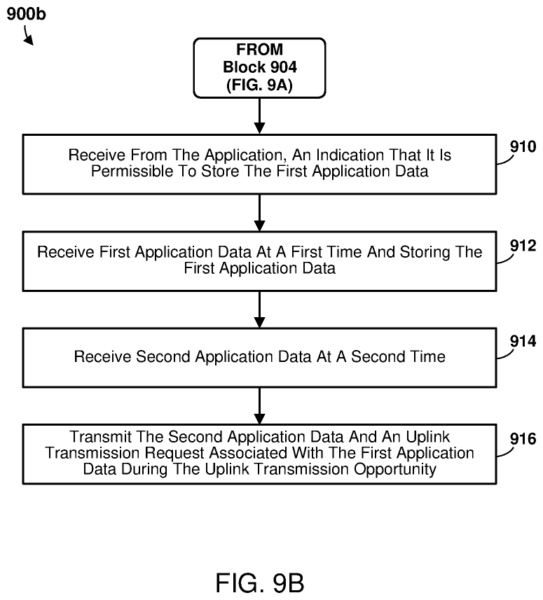

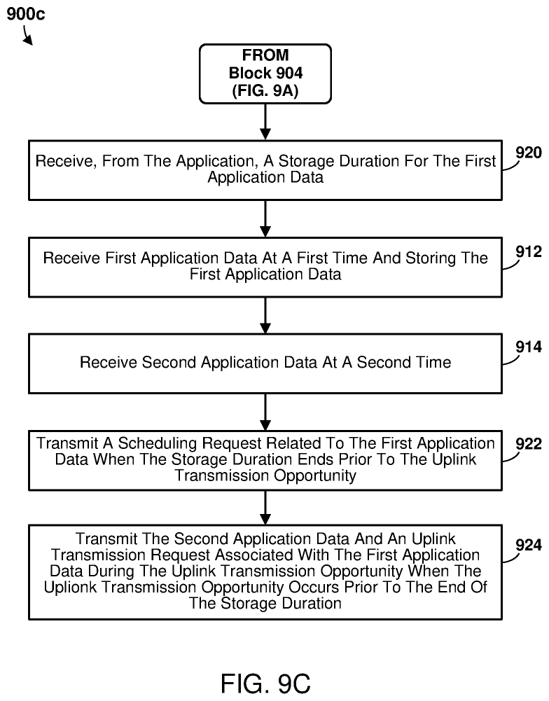

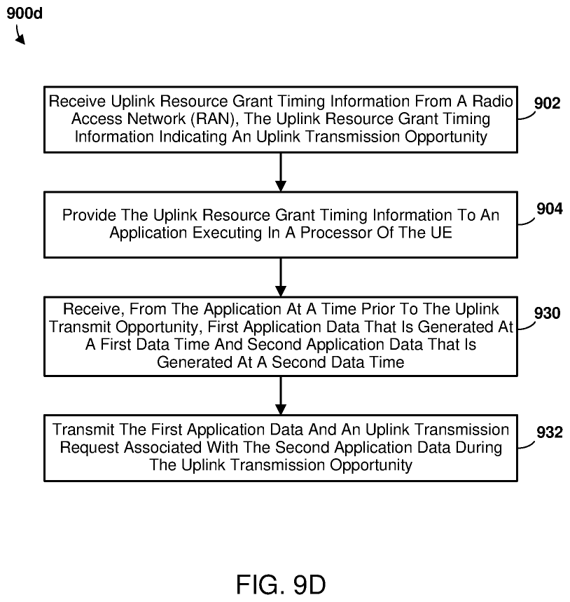

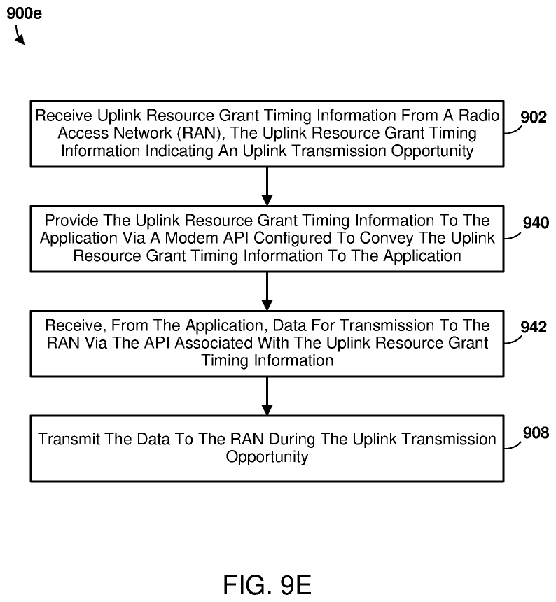

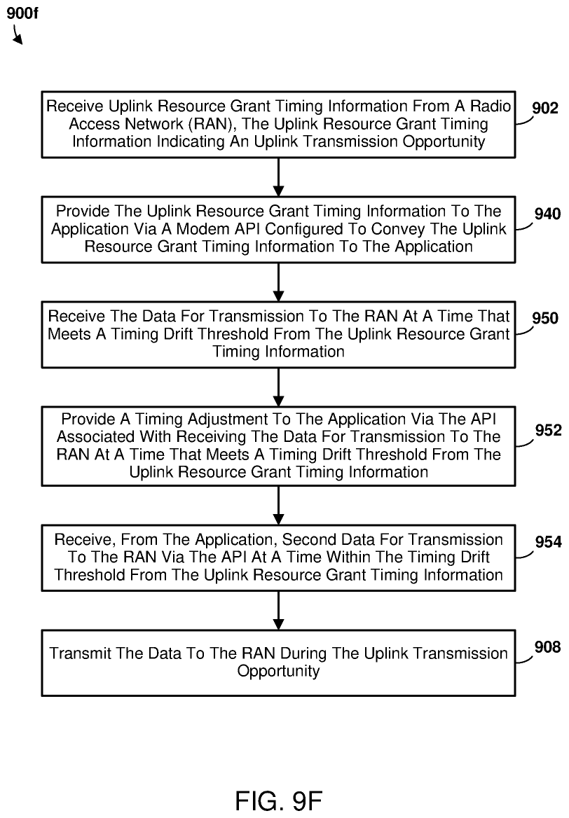

FIG. 9A is a process flow diagram illustrating a method 900a for uplink data transmission in accordance with various embodiments. With reference to FIGS. 1A-9A, the operations of the method 800a may be performed by a processor (such as the processor 210, 212, 214, 216, 218, 252, 260, 404) of a UE (such as the UE 120a-120e, 200, 320, 400, 602). The processor may be a modem processor or a processor coupled to or controlling the modem, and therefore is referred to generally as a “processor.”

In block 902, the processor may receive uplink resource grant timing information from a radio access network (RAN), the uplink resource grant timing information indicating an uplink transmission opportunity. In some embodiments, the processor may receive the uplink resource grant timing information via radio resource control (RRC) signaling. In some embodiments, the processor may receive an indication of an uplink period via RRC signaling and receiving a downlink control information (DCI) that indicates an offset value within the uplink period. In some embodiments, the processor may receive uplink grants in a DCI in a pattern that indicates an uplink period and an offset within the uplink period. For example, the processor may determine the uplink period and/or offset based on a pattern of received uplink grants in a DCI. Means for performing functions of the operations in block 902 may include the processor (e.g., 210, 212, 214, 216, 218, 252, 260, 404) executing the uplink resource grant module 434 and the timing information determining module 436, and the wireless transceiver (e.g., 266).

In block 904, the processor may provide the uplink resource grant timing information to an application executing in a processor of the UE. In some embodiments, the uplink resource grant timing information provided to the application includes an uplink period and an offset value within the uplink period that enables the application to send the data for transmission to the RAN during the uplink transmission opportunity. Means for performing functions of the operations in block 904 may include the processor (e.g., 210, 212, 214, 216, 218, 252, 260, 404) executing the timing information determining module 436 and the API module 438.

In block 906, the processor may receive, from the application, data for transmission to the RAN during the uplink transmission opportunity. Means for performing functions of the operations in block 906 may include the processor (e.g., 210, 212, 214, 216, 218, 252, 260, 404) executing the API module 438.

In block 908, the processor may transmit the data to the RAN during the uplink transmission opportunity. Means for performing functions of the operations in block 906 may include the processor (e.g., 210, 212, 214, 216, 218, 252, 260, 404) executing the TX/RX module 440.

FIGS. 9B-9F illustrate operations 900b-900f that may be performed as part of the method 900a for uplink data transmission according to various embodiments. With reference to FIGS. 1A-9F, the operations 900b-900f may be performed by a processor (such as the processor 210, 212, 214, 216, 218, 252, 260, 404) of a UE (such as the UE 120a-120e, 200, 320, 400, 602). Again, the processor performing operations 900b-900f may be a modem processor or a processor coupled to or controlling the modem, and therefore is referred to generally as a “processor.”

Referring to FIG. 9B, after the processor provides the uplink resource grant timing information to an application executing in a processor of the UE in block 904 as described, the processor may receive, from the application, an indication that it is permissible to store first application data in optional block 910. Means for performing functions of the operations in optional block 910 may include the processor (e.g., 210, 212, 214, 216, 218, 252, 260, 404) executing the API module 438 and the data storage management module 442.

In block 912, the processor may receive first application data at a first time and store the first application data. Means for performing functions of the operations in block 912 may include the processor (e.g., 210, 212, 214, 216, 218, 252, 260, 404) executing the API module 438 and the data storage management module 442.

In block 914, the processor may receive second application data at a second time. Means for performing functions of the operations in block 914 may include the processor (e.g., 210, 212, 214, 216, 218, 252, 260, 404) executing the API module 438 and the data storage management module 442.

In block 916, the processor may transmit the first application data to the RAN during the uplink transmission opportunity by transmitting the second application data and an uplink transmission request associated with the first application data during the uplink transmission opportunity. Means for performing functions of the operations in block 916 may include the processor (e.g., 210, 212, 214, 216, 218, 252, 260, 404) executing the timing information determining module 436, API module 438, and the TX/RX module 440, and the wireless transceiver 266.

Referring to FIG. 9C, after the processor provides the uplink resource grant timing information to an application executing in a processor of the UE in block 904 as described, the processor may receive, from the application, a storage duration for the first application data in block 920. Means for performing functions of the operations in optional block 910 may include the processor (e.g., 210, 212, 214, 216, 218, 252, 260, 404) executing the API module 438 and the data storage management module 442.

In block 912, the processor may receive first application data at a first time and store the first application data as described. In block 914, the processor may receive second application data at a second time as described.

In block 922, the processor may transmit a scheduling request related to the first application data when the storage duration ends prior to the uplink transmission opportunity. For example, when application data that may be (i.e., is permitted to be) aggregated with other application data is associated with a storage duration, the processor (e.g., the modem processor) may not be permitted to store (e.g., buffer) the application data for a duration longer than the storage duration. In such embodiments, if the data has not been transmitted when the end of the storage duration is reached (e.g., with another data flow), the processor may transmit to the RAN a scheduling request to request uplink communication resources to enable the transmission of the stored application data. Means for performing functions of the operations in block 922 may include the processor (e.g., 210, 212, 214, 216, 218, 252, 260, 404) executing the TX/RX module 440, the data storage management module 442, and the wireless transceiver 266.

In block 924, the processor may transmit the second application data and an uplink transmission request associated with the first application data during the uplink transmission opportunity after the first application data has been stored for the storage duration. Means for performing functions of the operations in block 924 may include the processor (e.g., 210, 212, 214, 216, 218, 252, 260, 404) executing the TX/RX module 440, the data storage management module 442, and the wireless transceiver 266.

Referring to FIG. 9D, after the processor provides the uplink resource grant timing information to an application executing in a processor of the UE in block 904 as described, the processor may receive, from the application at a time prior to the uplink transmit opportunity, first application data that is generated at a first data time and second application data that is generated at a second data time in block 930. Means for performing functions of the operations in block 930 may include the processor (e.g., 210, 212, 214, 216, 218, 252, 260, 404) executing the API module 438.

In block 932, the processor may transmit the first application data and an uplink transmission request associated with the second application data during the uplink transmission opportunity. Means for performing functions of the operations in block 932 may include the processor (e.g., 210, 212, 214, 216, 218, 252, 260, 404) executing the TX/RX module 440 and the wireless transceiver 266.

Referring to FIG. 9E, after the processor receives uplink resource grant timing information from the RAN in block 902 as described, the processor may provide the uplink resource grant timing information to the application via a modem application program interface (API) configured to convey the uplink resource grant timing information to the application in block 940. Means for performing functions of the operations in block 940 may include the processor (e.g., 210, 212, 214, 216, 218, 252, 260, 404) executing the timing information determining module 436 and the API module 438.

In block 942, the processor may receive, from the application, data for transmission to the RAN via the API associated with the uplink resource grant timing information. Means for performing functions of the operations in block 942 may include the processor (e.g., 210, 212, 214, 216, 218, 252, 260, 404) executing the API module 438.

The processor may transmit the data to the RAN during the uplink transmission opportunity in block 908 as described.

Referring to FIG. 9F, after the processor provides the uplink resource grant timing information to the application via the modem API configured to convey the uplink resource grant timing information to the application in block 940 as described, the processor may receive the data for transmission to the RAN at a time that meets a timing drift threshold from the uplink resource grant timing information. For example, the processor may receive the data for transmission at a time that is greater than or equal to the timing drift threshold relative to or compared to the uplink resource grant timing information (e.g., a next uplink transmission opportunity). Means for performing functions of the operations in block 950 may include the processor (e.g., 210, 212, 214, 216, 218, 252, 260, 404) executing the timing information determining module 436 and the API module 438.

In block 952, the processor may provide a timing adjustment to the application via the API associated with receiving the data for transmission to the RAN at a time that meets a timing drift threshold from the uplink resource grant timing information. Means for performing functions of the operations in block 950 may include the processor (e.g., 210, 212, 214, 216, 218, 252, 260, 404) executing the timing information determining module 436 and the API module 438.

In block 954, the processor may receive, from the application, second data for transmission to the RAN via the API at a time within the timing drift threshold from the uplink resource grant timing information. Means for performing functions of the operations in block 952 may include the processor (e.g., 210, 212, 214, 216, 218, 252, 260, 404) executing the API module 438.

The processor may transmit the data to the RAN during the uplink transmission opportunity in block 908 as described.

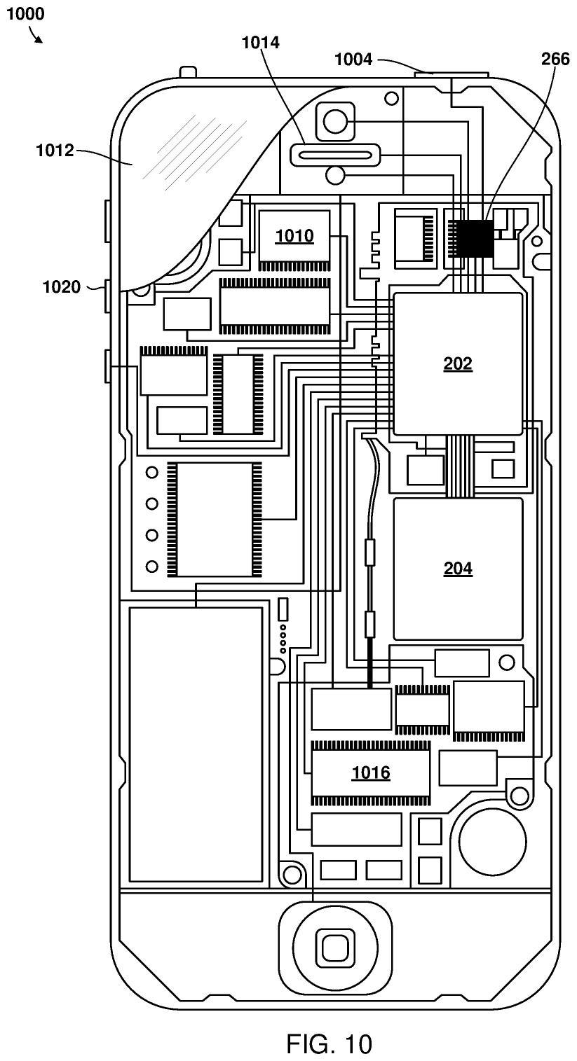

FIG. 10 is a component block diagram of a UE 1000 suitable for use with various embodiments. With reference to FIGS. 1A-10, various embodiments may be implemented on a variety of UEs 1000 (for example, the UEs 120a-120e, 200, 320, 402, 404), an example of which is illustrated in FIG. 10 in the form of a smartphone. The UE 1000 may include a first SOC 202 (for example, a SOC-CPU) coupled to a second SOC 204 (for example, a 5G capable SOC). The first and second SOCs 202, 204 may be coupled to internal memory 1016, a display 1012, and to a speaker 1014. Additionally, the UE 1000 may include an antenna 1004 for sending and receiving electromagnetic radiation that may be connected to a wireless transceiver 266 coupled to one or more processors in the first and/or second SOCs 202, 204. The UE 1000 may include menu selection buttons or rocker switches 1020 for receiving user inputs. The UE 1000 may include a sound encoding/decoding (CODEC) circuit 1010, which digitizes sound received from a microphone into data packets suitable for wireless transmission and decodes received sound data packets to generate analog signals that are provided to the speaker to generate sound. One or more of the processors in the first and second SOCs 202, 204, wireless transceiver 266 and CODEC 1010 may include a digital signal processor (DSP) circuit (not shown separately).

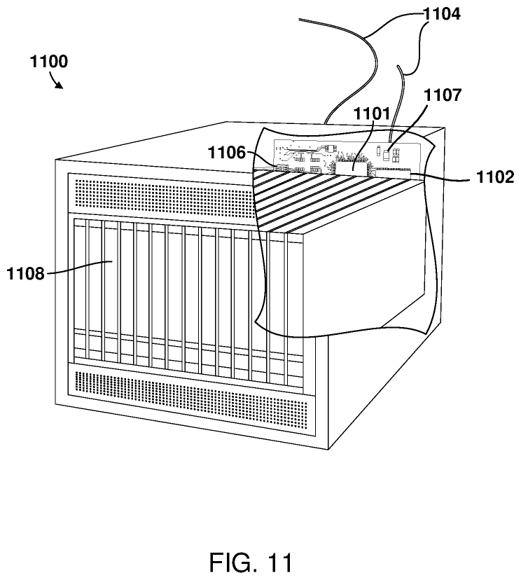

FIG. 11 is a component block diagram of a network device suitable for use with various embodiments. Such network devices (e.g., network device 110a-110d, 350, 406, 410, 414) may include at least the components illustrated in FIG. 11. With reference to FIGS. 1A-11, the network device 1100 may typically include a processor 1101 coupled to volatile memory 1102 and a large capacity nonvolatile memory, such as a disk drive 1108. The network device 1100 also may include a peripheral memory access device 1106 such as a floppy disc drive, compact disc (CD) or digital video disc (DVD) drive coupled to the processor 1101. The network device 1100 also may include network access ports 1104 (or interfaces) coupled to the processor 1101 for establishing data connections with a network, such as the Internet or a local area network coupled to other system computers and servers. The network device 1100 may include one or more antennas 1107 for sending and receiving electromagnetic radiation that may be connected to a wireless communication link. The network device 1100 may include additional access ports, such as USB, Firewire, Thunderbolt, and the like for coupling to peripherals, external memory, or other devices.

The processors of the UE 1000 and the network device 1100 may be any programmable microprocessor, microcomputer or multiple processor chip or chips that can be configured by software instructions (applications) to perform a variety of functions, including the functions of some implementations described below. In some wireless devices, multiple processors may be provided, such as one processor within an SOC 204 dedicated to wireless communication functions and one processor within an SOC 202 dedicated to running other applications.

Software applications may be stored in the memory 1016, 1102 before they are accessed and loaded into the processor. The processors may include internal memory sufficient to store the application software instructions.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the methods and operations disclosed herein may be substituted for or combined with one or more operations of the methods and operations disclosed herein.

Implementation examples are described in the following paragraphs. While some of the following implementation examples are described in terms of example methods, further example implementations may include: the example methods discussed in the following paragraphs implemented by a UE including a processor configured with processor-executable instructions to perform operations of the methods of the following implementation examples; the example methods discussed in the following paragraphs implemented by a UE including means for performing functions of the methods of the following implementation examples; and the example methods discussed in the following paragraphs may be implemented as a non-transitory processor-readable storage medium having stored thereon processor-executable instructions configured to cause a processor of a UE to perform the operations of the methods of the following implementation examples.

Example 1. A method performed by a modem processor of a user equipment (UE) for uplink data transmission, including receiving uplink resource grant timing information from a radio access network (RAN), the uplink resource grant timing information indicating an uplink transmission opportunity, providing the uplink resource grant timing information to an application executing in a processor of the UE, receiving, from the application, data for transmission to the RAN during the uplink transmission opportunity, and transmitting the data to the RAN during the uplink transmission opportunity.

Example 2. The method of example 1, in which the uplink resource grant timing information provided to the application includes an uplink period and an offset value within the uplink period that enables the application to send the data for transmission to the RAN during the uplink transmission opportunity.

Example 3. The method of either of examples 1 or 2, in which receiving the uplink resource grant timing information from the RAN includes receiving the uplink resource grant timing information via radio resource control (RRC) signaling.

Example 4. The method of any of examples 1-3, in which receiving the uplink resource grant timing information from the RAN includes receiving an indication of an uplink period via RRC signaling and receiving a downlink control information (DCI) that indicates an offset value within the uplink period.

Example 5. The method of any of examples 1-4, in which receiving the uplink resource grant timing information from the RAN includes receiving uplink grants in a DCI in a pattern that indicates an uplink period and an offset within the uplink period.

Example 6. The method of any of examples 1-5, in which receiving, from the application, data for transmission to the RAN during the uplink transmission opportunity includes receiving first application data at a first time and storing the first application data, and receiving second application data at a second time, and transmitting the first application data to the RAN during the uplink transmission opportunity includes transmitting the second application data and an uplink transmission request associated with the first application data during the uplink transmission opportunity.

Example 7. The method of example 6, further including receiving, from the application, an indication that it is permissible to store the first application data, in which receiving first application data at the first time and storing the first application data includes storing the first application data after receiving the indication that it is permissible to store the first application data.

Example 8. The method of example 6, further including receiving, from the application, a storage duration for the first application data, and transmitting a scheduling request related to the first application data when the storage duration ends prior to the uplink transmission opportunity, in which transmitting the data to the RAN during the uplink transmission opportunity includes transmitting the second application data and the uplink transmission request associated with the first application data during the uplink transmission opportunity when the uplink transmission opportunity occurs prior to an end of the storage duration.

Example 9. The method of any of examples 1-8, in which receiving, from the application, data for transmission to the RAN during the uplink transmission opportunity includes receiving, from the application at a time prior to the uplink transmit opportunity, first application data that is generated at a first data time and second application data that is generated at a second data time, and transmitting the data to the RAN during the uplink transmission opportunity includes transmitting the first application data and an uplink transmission request associated with the second application data during the uplink transmission opportunity.

Example 10. The method of any of examples 1-9, in which providing the uplink resource grant timing information to the application executing on the processor of the UE includes providing the uplink resource grant timing information to the application via a modem application program interface (API) configured to convey the uplink resource grant timing information to the application, and receiving, from the application, data for transmission to the RAN during the uplink transmission opportunity includes receiving, from the application, data for transmission to the RAN via the API associated with the uplink resource grant timing information.

Example 11. The method of example 10, in which receiving, from the application, data for transmission to the RAN via the API associated with the uplink resource grant timing information includes receiving the data for transmission to the RAN at a time that meets a timing drift threshold from the uplink resource grant timing information, and the method further includes providing a timing adjustment to the application via the API associated with receiving the data for transmission to the RAN at a time that meets a timing drift threshold from the uplink resource grant timing information, and receiving, from the application, second data for transmission to the RAN via the API at a time within the timing drift threshold from the uplink resource grant timing information.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running in a processor, a processor, an object, an executable, a thread of execution, a program, or a computer. By way of illustration, both an application running on a wireless device and the wireless device may be referred to as a component. One or more components may reside within a process or thread of execution and a component may be localized on one processor or core or distributed between two or more processors or cores. In addition, these components may execute from various non-transitory computer readable media having various instructions or data structures stored thereon. Components may communicate by way of local or remote processes, function or procedure calls, electronic signals, data packets, memory read/writes, and other known network, computer, processor, or process related communication methodologies.

A number of different cellular and mobile communication services and standards are available or contemplated in the future, all of which may implement and benefit from the various embodiments. Such services and standards include, e.g., third generation partnership project (3GPP), long term evolution (LTE) systems, third generation wireless mobile communication technology (3G), fourth generation wireless mobile communication technology (4G), fifth generation wireless mobile communication technology (5G) as well as later generation 3GPP technology, global system for mobile communications (GSM), universal mobile telecommunications system (UMTS), 3GSM, general packet radio service (GPRS), code division multiple access (CDMA) systems (e.g., cdmaOne, CDMA1020™), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), and integrated digital enhanced network (iDEN). Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, components, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality.

Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A user equipment (UE) for uplink data transmission, comprising:
a wireless transceiver; and
a processor configured with processor-executable instructions to:
receive uplink resource grant timing information from a radio access network (RAN), the uplink resource grant timing information indicating an uplink transmission opportunity;
provide the uplink resource grant timing information to an application executing in a processor of the UE;
receive, from the application, data for transmission to the RAN during the uplink transmission opportunity; and
transmit the data to the RAN during the uplink transmission opportunity.

2. The UE of claim 1, wherein the processor is further configured with processor-executable instructions such that the uplink resource grant timing information provided to the application comprises an uplink period and an offset value within the uplink period that enables the application to send the data for transmission to the RAN during the uplink transmission opportunity.

3. The UE of claim 1, wherein the processor is further configured with processor-executable instructions to receive the uplink resource grant timing information via radio resource control (RRC) signaling.

4. The UE of claim 1, wherein the processor is further configured with processor-executable instructions to receive an indication of an uplink period via RRC signaling and receiving a downlink control information (DCI) that indicates an offset value within the uplink period.

5. The UE of claim 1, wherein the processor is further configured with processor-executable instructions to receive uplink grants in a DCI in a pattern that indicates an uplink period and an offset within the uplink period.

6. The UE of claim 1, wherein the processor is further configured with processor-executable instructions to:
receive first application data at a first time and storing the first application data;
receive second application data at a second time; and
transmit the second application data and an uplink transmission request associated with the first application data during the uplink transmission opportunity.

7. The UE of claim 6, wherein the processor is further configured with processor-executable instructions to:
receive, from the application, an indication that it is permissible to store the first application data; and
store the first application data after receiving the indication that it is permissible to store the first application data.

8. The UE of claim 6, wherein the processor is further configured with processor-executable instructions to:
receiving, from the application, a storage duration for the first application data;
transmit the second application data and the uplink transmission request associated with the first application data during the uplink transmission opportunity when the uplink transmission opportunity occurs prior to an end of the storage duration; and
transmit a scheduling request related to the first application data when the storage duration ends prior to the uplink transmission opportunity.

9. The UE of claim 1, wherein the processor is further configured with processor-executable instructions to:
receive, from the application at a time prior to the uplink transmit opportunity, first application data that is generated at a first data time and second application data that is generated at a second data time; and
transmit the first application data and an uplink transmission request associated with the second application data during the uplink transmission opportunity.

10. The UE of claim 1, wherein the processor is further configured with processor-executable instructions to:
provide the uplink resource grant timing information to the application via a modem application program interface (API) configured to convey the uplink resource grant timing information to the application; and
receive, from the application, data for transmission to the RAN via the API associated with the uplink resource grant timing information.

11. The UE of claim 10, wherein the processor is further configured with processor-executable instructions to:
receive the data for transmission to the RAN at a time that meets a timing drift threshold from the uplink resource grant timing information;
provide a timing adjustment to the application via the API associated with receiving the data for transmission to the RAN at a time that meets a timing drift threshold from the uplink resource grant timing information; and
receive, from the application, second data for transmission to the RAN via the API at a time within the timing drift threshold from the uplink resource grant timing information.

12. A method performed by a modem processor of a user equipment (UE) for uplink data transmission, comprising:
receiving uplink resource grant timing information from a radio access network (RAN), the uplink resource grant timing information indicating an uplink transmission opportunity;
providing the uplink resource grant timing information to an application executing in a processor of the UE;
receiving, from the application, data for transmission to the RAN during the uplink transmission opportunity; and
transmitting the data to the RAN during the uplink transmission opportunity.

13. The method of claim 12, wherein the uplink resource grant timing information provided to the application comprises an uplink period and an offset value within the uplink period that enables the application to send the data for transmission to the RAN during the uplink transmission opportunity.

14. The method of claim 12, wherein receiving the uplink resource grant timing information from the RAN comprises receiving the uplink resource grant timing information via radio resource control (RRC) signaling.

15. The method of claim 12, wherein receiving the uplink resource grant timing information from the RAN comprises receiving an indication of an uplink period via RRC signaling and receiving a downlink control information (DCI) that indicates an offset value within the uplink period.

16. The method of claim 12, wherein receiving the uplink resource grant timing information from the RAN comprises receiving uplink grants in a DCI in a pattern that indicates an uplink period and an offset within the uplink period.

17. The method of claim 12, wherein:
receiving, from the application, data for transmission to the RAN during the uplink transmission opportunity comprises:
receiving first application data at a first time and storing the first application data; and
receiving second application data at a second time; and
transmitting the first application data to the RAN during the uplink transmission opportunity comprises transmitting the second application data and an uplink transmission request associated with the first application data during the uplink transmission opportunity.

18. The method of claim 17, further comprising:
receiving, from the application, an indication that it is permissible to store the first application data,
wherein receiving first application data at the first time and storing the first application data comprises storing the first application data after receiving the indication that it is permissible to store the first application data.

19. The method of claim 17, further comprising:
receiving, from the application, a storage duration for the first application data; and
transmitting a scheduling request related to the first application data when the storage duration ends prior to the uplink transmission opportunity,
wherein transmitting the data to the RAN during the uplink transmission opportunity comprises transmitting the second application data and the uplink transmission request associated with the first application data during the uplink transmission opportunity when the uplink transmission opportunity occurs prior to an end of the storage duration.

20. The method of claim 12, wherein:
receiving, from the application, data for transmission to the RAN during the uplink transmission opportunity comprises receiving, from the application at a time prior to the uplink transmit opportunity, first application data that is generated at a first data time and second application data that is generated at a second data time; and
transmitting the data to the RAN during the uplink transmission opportunity comprises transmitting the first application data and an uplink transmission request associated with the second application data during the uplink transmission opportunity.

21. The method of claim 12, wherein:
providing the uplink resource grant timing information to the application executing on the processor of the UE comprises providing the uplink resource grant timing information to the application via a modem application program interface (API) configured to convey the uplink resource grant timing information to the application; and
receiving, from the application, data for transmission to the RAN during the uplink transmission opportunity comprises receiving, from the application, data for transmission to the RAN via the API associated with the uplink resource grant timing information.

22. The method of claim 21, wherein:
receiving, from the application, data for transmission to the RAN via the API associated with the uplink resource grant timing information comprises receiving the data for transmission to the RAN at a time that meets a timing drift threshold from the uplink resource grant timing information; and
the method further comprises:
providing a timing adjustment to the application via the API associated with receiving the data for transmission to the RAN at a time that meets a timing drift threshold from the uplink resource grant timing information; and
receiving, from the application, second data for transmission to the RAN via the API at a time within the timing drift threshold from the uplink resource grant timing information.

23. A user equipment (UE), comprising:
means for receiving uplink resource grant timing information from a radio access network (RAN), the uplink resource grant timing information indicating an uplink transmission opportunity;
means for providing the uplink resource grant timing information to an application executing in the UE;
means for receiving, from the application, data for transmission to the RAN during the uplink transmission opportunity; and
means for transmitting the data to the RAN during the uplink transmission opportunity.

24. The UE of claim 23, wherein the uplink resource grant timing information provided to the application comprises an uplink period and an offset value within the uplink period that enables the application to send the data for transmission to the RAN during the uplink transmission opportunity.

25. The UE of claim 23, wherein means for receiving the uplink resource grant timing information from the RAN comprises means for receiving the uplink resource grant timing information via radio resource control (RRC) signaling.

26. The UE of claim 23, wherein means for receiving the uplink resource grant timing information from the RAN comprises means for receiving an indication of an uplink period via RRC signaling and receiving a downlink control information (DCI) that indicates an offset value within the uplink period.

27. The UE of claim 23, wherein means for receiving the uplink resource grant timing information from the RAN comprises means for receiving uplink grants in a DCI in a pattern that indicates an uplink period and an offset within the uplink period.

28. The UE of claim 23, wherein:
means for receiving, from the application, data for transmission to the RAN during the uplink transmission opportunity comprises:
means for receiving first application data at a first time and storing the first application data; and
means for receiving second application data at a second time; and
means for transmitting the first application data to the RAN during the uplink transmission opportunity comprises means for transmitting the second application data and an uplink transmission request associated with the first application data during the uplink transmission opportunity.

29. The UE of claim 28, further comprising:
means for receiving, from the application, an indication that it is permissible to store the first application data,
wherein means for receiving first application data at the first time and storing the first application data comprises means for storing the first application data after receiving the indication that it is permissible to store the first application data.

30. The UE of claim 28, further comprising:
means for receiving, from the application, a storage duration for the first application data; and
means for transmitting a scheduling request related to the first application data when the storage duration ends prior to the uplink transmission opportunity,
wherein means for transmitting the data to the RAN during the uplink transmission opportunity comprises means for transmitting the second application data and the uplink transmission request associated with the first application data during the uplink transmission opportunity when the uplink transmission opportunity occurs prior to an end of the storage duration.

31. The UE of claim 23, wherein:
means for receiving, from the application, data for transmission to the RAN during the uplink transmission opportunity comprises means for receiving, from the application at a time prior to the uplink transmit opportunity, first application data that is generated at a first data time and second application data that is generated at a second data time; and
means for transmitting the data to the RAN during the uplink transmission opportunity comprises means for transmitting the first application data and an uplink transmission request associated with the second application data during the uplink transmission opportunity.

32. The UE of claim 23, wherein:
means for providing the uplink resource grant timing information to the application executing on the processor of the UE comprises means for providing the uplink resource grant timing information to the application via a modem application program interface (API) configured to convey the uplink resource grant timing information to the application; and
means for receiving, from the application, data for transmission to the RAN during the uplink transmission opportunity comprises means for receiving, from the application, data for transmission to the RAN via the API associated with the uplink resource grant timing information.

33. The UE of claim 32, wherein:
means for receiving, from the application, data for transmission to the RAN via the API associated with the uplink resource grant timing information comprises means for receiving the data for transmission to the RAN at a time that meets a timing drift threshold from the uplink resource grant timing information; and
the UE further comprises:
means for providing a timing adjustment to the application via the API associated with receiving the data for transmission to the RAN at a time that meets a timing drift threshold from the uplink resource grant timing information; and
means for receiving, from the application, second data for transmission to the RAN via the API at a time within the timing drift threshold from the uplink resource grant timing information.

34. A non-transitory processor-readable medium having stored thereon processor-executable instructions configured to cause a processor in a user equipment (UE) to perform operations comprising:
receiving uplink resource grant timing information from a radio access network (RAN), the uplink resource grant timing information indicating an uplink transmission opportunity;
providing the uplink resource grant timing information to an application executing in a processor of the UE;
receiving, from the application, data for transmission to the RAN during the uplink transmission opportunity; and
transmitting the data to the RAN during the uplink transmission opportunity.
